(19) United States
(12) Patent Application Publication
(10) Pub. No.: US 2005/0014093 A1
(43) Pub. Date: Jan. 20, 2005

(54) Planographic printing plate precursor

(75) Inventors: Kotaro Watanabe, Shizuoka-ken (JP); Ippei Nakamura, Shizuoka-ken (JP); Ikuo Kawauchi, Shizuoka-ken (JP); Yusuke Hatanaka, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/891,082

(22) Filed: Jul. 15, 2004

(30) Foreign Application Priority Data
Jul. 17, 2003 (JP) 2003-275844

(51) Int. Cl. G03C 1/76

(52) U.S. Cl. 430/270.1

(57) ABSTRACT

The present invention relates to a positive-type planographic printing plate precursor comprising: a hydrophilic substrate; an image recording layer including a novolak resin (A) and a light-to-heat conversion agent (B), disposed on the substrate, the image recording layer increasing in solubility in an aqueous alkali solution when exposed to light emitted from an infrared laser, wherein the weight average molecular weight (Mw) of the novolak resin (A) is in a range of 500 to 10000 based on polystyrene, the molecular weight being found by a gel permeation chromatographic (GPC) method using monodispersion polystyrene as a standard, and the degree of dispersion (Mw/Mn) is 1.7 or less when the weight average molecular weight (Mw) is 500 to 3000, the degree of dispersion (Mw/Mn) is 2.0 or less when the weight average molecular weight (Mw) is 3000 to 4500, and the degree of dispersion (Mw/Mn) of the novolak resin (A) fulfills the following equation: (Mw/Mn)≦{(4·Mw−1500)/5500}, when the weight average molecular weight (Mw) is 4500 to 10000.

### CROSS-REFERENCE TO RELATED APPLICATION

This application claims priority under 35 USC 119 from Japanese Patent Application No. 2003-275844, the disclosures of which are incorporated by reference herein.

### BACKGROUND OF THE INVENTION

1. Field of the Invention

The present invention relates to a planographic printing plate precursor and, particularly, to a positive-type planographic printing plate precursor for exposure by an infrared laser used in direct plate-making, i.e., a positive-type planographic printing plate precursor which can be processed to a printing plate directly by digital signals from computers or the like.

2. Description of the Related Art

The development of lasers in recent years has been significant, and particularly, with regard to solid lasers and semiconductor lasers emitting near-infrared and infrared rays, high output, small-sized lasers have become readily available. These lasers are very useful as an exposure light source when processing a printing plate directly by digital data of computers or the like.

Positive-type planographic printing plate materials used for exposure by infrared lasers contain, as essential components, a binder resin soluble in an aqueous alkali solution, an IR dye which absorbs light to generate heat and the like. In an unexposed portion (i.e., image portion), the IR dye and the like serve as a dissolution inhibitor that substantially decreases the solubility of the binder resin due to interaction with the binder resin. Meanwhile, in an exposed portion (i.e., non-image portion), interaction of the IR dye and the like with the binder resin is weakened by the generated heat, and the IR dye and the like are dissolved in an alkali developer to form a planographic printing plate.

However, such positive-type planographic printing plate materials for exposure by infrared lasers do not have sufficient difference between solubility resistance to a developer at an unexposed portion (image portion) and solubility to a developer at an exposed portion (non-image portion) under various usage conditions, posing a problem in that excess developing and inferior developing are easily caused by variations in usage conditions.

Also, the image-forming ability of the positive-type planographic printing plate precursor used for exposure by an infrared laser depends on the heat generated by exposure using an infrared laser on the surface of the recording layer. Therefore, in the vicinity of the substrate, the quantity of heat available for forming an image, namely, for making the recording layer soluble is decreased by thermal diffusion to the support, resulting in low sensitivity. There is therefore a problem in that the recording layer has quite insufficient effect of losing development-inhibiting ability at the non-image portion, whereby the difference in solubility to a developer between the image portion and the non-image portion is decreased, resulting in insufficient highlight reproducibility.

In order to solve the above-described problem concerning highlight reproducibility, one can consider using a recording layer made of a material which is easily developed and thus can easily form a non-image portion. However, there are problems in that the image portion of such a recording layer is chemically weak, i.e., inferior in chemical resistance and thus is easily damaged by a developer and an ink cleaning solvent and a plate cleaner used during printing.

In order to solve the above problem, there has been disclosed a planographic printing plate precursor provided with a recording layer comprising a lower layer containing an acryl resin and having high solubility to alkali soution and an upper layer containing a water-insoluble and alkali-soluble resin and an infrared absorber, in which solubility in an aqueous alkali solution greatly increases by exposure (see, for example, Japanese Patent Application Laid-Open (JP-A) No. 10-250255). This planographic printing plate precursor can improve sensitivity and chemical resistance. However, there is a problem in that adhesion between the substrate and the recording layer is insufficient, leading to inferior printing durability.

As other methods of improving image discrimination of a positive-type planographic printing plate material, techniques have been proposed in which a phenolic hydroxyl group-containing compound is added (see, for example, JP-A No. 2000-241966). However, although this phenolic hydroxyl group-containing compound improves the removability (solubility) of a non-image portion in an alkali developer, the compound improves the solubility of an image portion at the same time, giving rise to a problem of reducing the sharpness of an image. This tendency is significant particularly in fine lines and dot image regions having a low area ratio. When carrying out an operation of wiping dust on the plate surface by a cleaner during printing, defects of fine dots appear and a problem of reduced entanglement, namely misalignment of fine lines occur. Therefore, there has been a desire for further improvements.

### SUMMARY OF THE INVENTION

In consideration of the above drawbacks of the prior art, an object of the present invention is to provide a positive-type planographic printing plate precursor which enables direct plate-making based on digital signals by scanning exposure using, for example, an infrared laser and is superior in printing durability and chemical resistance.

The present inventors have made earnest studies and, as a result, have found that the above problem can be solved by using an alkali-soluble resin having a molecular weight falling in a specified range and a specific degree of dispersion, thereby completing the invention.

A first aspect of the invention is to provide a positive-type planographic printing plate precursor comprising: a hydrophilic substrate; and an image recording layer including a novolak resin (A) and a light-to-heat conversion agent (B), disposed on the substrate, the image recording layer increasing in solubility in an aqueous alkali solution when exposed to light emitted from an infrared laser, wherein the weight average molecular weight (Mw) of the novolak resin (A) ranges from 500 to 3000 as the equivalent molecular weight of polystyrene, the molecular weight being measured by a gel permeation chromatographic (GPC) method using monodispersion polystyrene as a standard, and the degree of dispersion (Mw/Mn) of the novolak resin (A) is 1.7 or less.

When the weight average molecular weight of the novolak resin (A) based on polystyrene is measured by a gel permeation chromatographic (GPC) method using monodispersion polystyrene as a standard, it is desirable that GPC-pattern area ratios of the weight average molecular weights each falling in ranges from 50 to 150, 150 to 350, and 350 to 550 be 1% or less, 10% or less, and 20% or less, respectively, based on the total area.

A second aspect of the invention is to provide a positive-type planographic printing plate precursor comprising: a hydrophilic substrate; and an image recording layer including a novolak resin (A) and a light-to-heat conversion agent (B), disposed on the substrate, the image recording layer increasing in solubility in an aqueous alkali solution when exposed to light emitted from an infrared laser, wherein the weight average molecular weight (Mw) of the novolak resin (A) ranges from 3000 to 4500 based on polystyrene, the molecular weight being measured by a gel permeation chromatographic (GPC) method using monodispersion polystyrene as a standard, and the degree of dispersion (Mw/Mn) of the novolak resin (A) is 2.0 or less.

When the weight average molecular weight of the novolak resin (A) based on polystyrene is measured by a gel permeation chromatographic (GPC) method using monodispersion polystyrene as a standard, it is desirable that the GPC-pattern area ratios of the weight average molecular weights each falling in ranges from 50 to 150, 150 to 350, and 350 to 550 be 1% or less, 4% or less, and 4.5% or less, respectively, based on the total area.

A third aspect of the invention is to provide a positive type planographic printing plate precursor comprising: a hydrophilic substrate; and an image recording layer including a novolak resin (A) and a light-to-heat conversion agent (B), disposed on the substrate, the image recording layer increasing in solubility in an aqueous alkali solution when exposed to light emitted from an infrared laser, wherein the weight average molecular weight (Mw) of the novolak resin (A) ranges from 4500 to 10000 based on polystyrene, the molecular weight being measured by a gel permeation chromatographic (GPC) method using monodispersion polystyrene as a standard, and the degree of dispersion (Mw/Mn) of the novolak resin (A) satisfies the following equation: (Mw/Mn)≦{(4·Mw−1500)/5500}.

When the weight average molecular weight of the novolak resin (A) based on polystyrene is measured by a gel permeation chromatographic (GPC) method using monodispersion polystyrene as a standard, it is desirable that GPC-pattern area ratios of the weight average molecular weights each falling in ranges from 50 to 150, 150 to 350, and 350 to 550 be 1% or less, 3% or less, and 3.5% or less, respectively, based on the total area.

The positive-type planographic printing plate of the invention enables direct plate-making based on digital signals by scanning exposure using, for example, an infrared laser and uses a novolak resin having a specific molecular weight distribution in the recording layer. It is therefore possible to form an image which is superior in printing durability and chemical resistance, particularly in printing durability of images such as fine lines and fine dots, and has excellent contrast property.

### DETAILED DESCRIPTION OF THE INVENTION

Embodiments of the present invention will be explained in detail.

The positive-type planographic printing plate of the invention has an image recording layer including a novolak resin (A) and a light-to-heat conversion agent (B), the image recording layer increasing in solubility in an aqueous alkali solution when exposed to light emitted from an infrared laser. It has been found that the novolak resin (A) is prepared so as to have an optimum degree of dispersion (Mw/Mn) corresponding to the weight average molecular weight (Mw) to thereby develop superb characteristics.

Namely, in a first embodiment of the invention, the novolak resin (A) used in the image recording layer has a weight average molecular weight (Mw) in a range of 500 to 3000 and a degree of dispersion (Mw/Mn) of 1.7 or less. As the weight average molecular weight in the invention, a value based on polystyrene, which value is measured by gel permeation chromatography (GPC) method using monodispersion polystyrene as a standard, is adopted.

The weight average molecular weight of the novolak resin used in this embodiment must be in a range of 500 to 3000 and is preferably in a range of 1500 to 3000 and more preferably in a range of 2000 to 3000.

It is preferable that not only the degree of dispersion (Mw/Mn) be 1.7 or less but also the distribution of molecular weight be as follows: the GPC-pattern area ratios of the weight average molecular weights each falling in ranges from 50 to 150, 150 to 350, and 350 to 550 be 1% or less, 10% or less, and 20% or less, respectively, based on the total area. Specifically, the proportion of low-molecular weight components in terms of the average molecular weight is preferably a specified ratio or less. The respective GPC-pattern area ratios are more preferably 1% or less, 10% or less, and 15% or less, respectively, based on the total area, and further more preferably 1% or less, 10% or less, and 10% or less, respectively, based on the total area.

In a second embodiment of the invention, the novolak resin (A) used in the image recording layer has a weight average molecular weight (Mw) in a range of 3000 to 4500 and a degree of dispersion (Mw/Mn) of 2.0 or less. The weight average molecular weight is preferably in a range of 3000 to 4000.

It is preferable that not only the degree of dispersion (Mw/Mn) be 2.0 or less but also the distribution of molecular weight be as follows: the GPC-pattern area ratios of the weight average molecular weights each falling in ranges from 50 to 150, 150 to 350, and 350 to 550 be 1% or less, 4% or less, and 4.5% or less, respectively, based on the total area. The respective GPC-pattern area ratios are more preferably 1% or less, 3.5% or less, and 4.0% or less, respectively, based on the total area, and further more preferably 1% or less, 3% or less, and 3.5% or less, respectively, based on the total area.

In a third embodiment of the invention, the weight average molecular weight (Mw) of the novolak resin (A) used in the image recording layer is in a range of 4500 to 10000 and the degree of dispersion (Mw/Mn) of the novolak resin (A) satisfies the following equation: (Mw/Mn)≦{(4·Mw−1500)/5500}. The weight average molecular weight (Mw) is preferably in a range of 4500 to 8000, more preferably in a range of 4500 to 7000 and most preferably in a range of 4500 to 6000.

The degree of dispersion (Mw/Mn) of the novolak resin (A) satisfies the following equation: preferably (Mw/Mn)≦{(3·Mw+3000)/5500}, more preferably (Mw/Mn)≦{(2·Mw+7500)/5500} and most preferably (Mw/Mn)≦{(3·Mw−2500)/5500}.

It is preferable that not only the degree of dispersion (Mw/Mn) be 2.0 or less but also the distribution of molecular weight be as follows: the GPC-pattern area ratios of the weight average molecular weights each falling in ranges from 50 to 150, 150 to 350, and 350 to 550 be 1% or less, 3% or less, and 3.5% or less, respectively, based on the total area. The respective GPC-pattern area ratios are more preferably 1% or less, 2.5% or less, and 3.0% or less, respectively, based on the total area, and further more preferably 1% or less, 2.5% or less, and 2.5% or less, respectively, based on the total area, and most preferably 1% or less, 2.0% or less, and 2.5% or less, respectively, based on the total area.

No particular limitation is imposed on the novolak resin insofar as the weight average molecular weight and the degree of dispersion are respectively in the above ranges, and a general novolak resin containing, as its structural unit, a resin obtained by condensing phenol or substituted phenols, cresol, xylenol or the like by aldehydes may be used.

Although the distribution of molecular weight may be controlled by a specific synthetic method exemplified below, it may also be controlled by removing low-molecular weight components of the novolak resin obtained by the conventional synthetic method.

As a method of producing the novolak resin having a specified distribution of molecular weight according to the invention, there are methods described in “NEW EXPERIMENTAL CHEMISTRY LECTURE [19]” POLYMER CHEMISTRY [I] (1993, Maruzen Co., Ltd.), Clause No. 300.

According to the above-described, phenol or substituted phenols (e.g., xylenol or cresols) are reacted with an aqueous formaldehyde solution in a solvent by using an acid as a catalyst to bond the o-position or p-position of the phenol and the substituted phenol component with formaldehyde by dehydration-condensation.

After the novolak resin obtained in this manner is dissolved in an organic polar solvent, a non-polar solvent is added by an appropriate amount and the novolak resin solution is allowed to stand for several hours. As a consequence, the solution is separated into two layers.

Only the lower layer of the two layers, resulting from separation of the solution, is concentrated, whereby a novolak resin whose molecular weight is in a specific range can be obtained.

Examples of the organic polar solvent include acetone, methyl alcohol and ethyl alcohol. Examples of the non-polar solvent include hexane and petroleum ether.

A novolak resin fraction can be obtained not only by the production method mentioned above but also by dissolving a novolak resin in a water-soluble organic polar solvent followed by adding water to form a precipitate as described in Japanese Patent Application National Publication (Laid-Open) No. 2001-506294.

In order to obtain a novolak resin having a small degree of dispersion, it is possible to adopt a method in which a novolak resin obtained by dehydration condensation among phenol derivatives is dissolved in an organic polar solvent and is then subjected to silica gel for molecular weight fractionation.

The dehydration condensation of the o-position or p-position of phenol and substituted phenol components with formaldehyde may be carried out by adding phenol and substituted phenol components in a total concentration of 60 to 90% by weight and preferably 70 to 80% by weight in a solvent solution, formaldehyde in a molar ratio of 0.2 to 2.0, preferably 0.4 to 1.4 and particularly preferably 0.6 to 1.2 to the total mol number of phenol and substituted phenol components, and further adding an acid catalyst in a molar ratio of 0.01 to 0.1 and preferably 0.02 to 0.05 to the total mol number of phenol and substituted phenol components under a condition of a temperature range of 10° C. to 150° C. and by stirring for several hours with keeping the temperature in the above range.

The reaction temperature is preferably in a range of 70° C. to 150° C. and more preferably in a range of 90° C. to 140° C.

Examples of the above solvent to be used may include water, acetic acid, methanol, ethanol, 2-propanol, 2-methoxyethanol, ethyl propionate, ethoxyethyl propionate, 4-methyl-2-pentanone, dioxane, xylene and benzene.

Also, examples of the above acid catalyst may include hydrochloric acid, sulfuric acid, p-toluenesulfonic acid, pjosphoric acid, oxalic acid, tartaric acid, citric acid, zinc acetate, manganese acetate, cobalt acetate, magnesium methylsulfonate, aluminum chloride and zinc oxide.

The residual monomers and dimers left in the synthesized phenol resin are preferably removed by distillation.

General methods of controlling the distribution of molecular weight are exemplified here. However, needless to say, the method of preparing a novolak resin having properties suitable to the invention is not limited to these general methods and known methods such as a method in which the distribution of molecular weight is controlled by using a specific acid catalyst and solvent, may be properly applied.

Specific examples of the novolak resins which are obtained in the above-described manner and preferably used in the planographic printing plate precursor of the invention are described together with the composition, molecular weight and the distribution of molecular weight of each novolak resin in Tables 1 and 2 shown below: these examples are, however, not intended to be limiting of the invention.

In the following Table 1 and 2, m indicates an m-cresol novolak, p indicates a p-cresol novolak, o indicates an o-cresol novolak, Ph indicates a phenol novolak and Xy indicates a xylenol novolak.

TABLE 1

| | | Weight average | Degree of |
|---|---|---|---|
| Composition | Compositional ratio | molecular weight | dispersion |
| m/p | 70/30 | 4200 | 1.8 |
| Ph/m/p | 50/40/10 | 7700 | 2.8 |
| 2,5-Xy/o/m/p/Ph | 10/30/30/10/20 | 5500 | 2.4 |
| 2,3-Xy/m/p | 20/40/40 | 2800 | 1.6 |
| Ph/m/o | 55/35/10 | 9800 | 2.8 |
| Ph/m | 30/70 | 8700 | 5.2 |
| m | 100 | 7400 | 4.5 |
| m/p | 60/40 | 5900 | 3.4 |
| Ph/m | 20/80 | 6300 | 1.9 |
| 3,4-xy/Ph | 25/75 | 4800 | 1.8 |
| Ph | 100 | 2200 | 1.3 |
| m | 100 | 2800 | 1.6 |
| o | 100 | 2100 | 1.5 |
| p | 100 | 1600 | 1.7 |

TABLE 2

| | Compositional | Weight average | Degree of | 50-150 | 150-350 | 350-550 |
|---|---|---|---|---|---|---|
| Composition | ratio | molecular weight | dispersion | (%) | (%) | (%) |
| m/p | 60/40 | 3000 | 1.5 | 0.5 | 2.8 | 1.2 |
| m/p | 70/30 | 4100 | 1.9 | 0.3 | 0.8 | 3 |
| m/p | 80/20 | 5300 | 2.5 | 0.2 | 0.4 | 0.8 |
| Ph/m/p | 50/40/10 | 7200 | 4.6 | 0.4 | 1 | 1.3 |
| 2,5-Xy/o/m/p/Ph | 10/30/30/10/20 | 5200 | 1.7 | 0.3 | 1.2 | 1.6 |
| Ph/m/o | 55/35/10 | 9300 | 2.9 | 0.2 | 0.3 | 0.4 |
| Ph/m | 20/80 | 8800 | 5.1 | 0.4 | 2 | 2.2 |
| Ph | 100 | 2200 | 1.3 | 0.7 | 2.5 | 2.8 |
| m | 100 | 1800 | 1.6 | 0.3 | 1.5 | 7 |
| o | 100 | 1600 | 1.4 | 0.5 | 2 | 15 |
| p | 100 | 1600 | 1.6 | 0.2 | 8 | 5 |

The amount of the novolak resin (A) to be added is preferably 0.1 to 20% by weight, more preferably 0.2 to 10% by weight and most preferably in a range of 0.2 to 5.0% by weight based on the total solid in the image recording layer of the planographic printing plate precursor of the invention, from the viewpoint of achieving an effect of improving printing durability and chemical resistance while keeping high sensitivity.

In the present invention, the aforementioned specific novolak resin may be used either on its own or combined with another type of novolak resin. It should be noted that, in a case in which two or more types of novolak resins are used, at least one of the novolak resins must be the specific novolak resin of the present invention.

In the image recording layer according to the invention, a water-insoluble and aqueous alkali-soluble resin other than the aforementioned specific novolak resin (hereinafter referred to as “other alkali-soluble resin”) may be combined. The combination of these other novolak resins is preferable from the viewpoint of enlarging a development latitude.

Examples of the other alkali-soluble resin include a polyhydroxystyrene, polyhydroxystyrene halide, N-(4-hydroxyphenyl)methacrylamide copolymer, hydroquinone monomethacrylate copolymer, sulfonylimide type polymer described in JP-A No. 7-28244 and carboxyl group-containing polymer described in JP-A No. 7-36184.

Besides the above, various alkali-soluble polymer compounds such as acryl type resins containing a phenolic hydroxyl group as disclosed in JP-A No. 51-34711, acryl type resins containing a sulfonamide group as disclosed in JP-A No. 2-866 and urethane resins may be used.

These other alkali-soluble resins are preferably those having a weight average molecular weight of 500 to 200,000 and more preferably those having a number average molecular weight of 200 to 60,000.

These other alkali-soluble resins may be used either singly or in combinations of two or more. The amount of the resin which may be combined is preferably 0.5 to 30% by weight and more preferably in a range of 0.5 to 20% by weight based on the total solid of the recording layer.

Any material may be used as the light to heat conversion agent (B) used in the invention without any particular limitation to the region of absorption wavelength insofar as it absorbs light energy radiation to generate heat. However, preferable examples of the light to heat conversion agent include various dyes and pigments known as infrared absorbing dyes or pigments having an absorption maximum at a wavelength of 700 nm to 1200 nm from the viewpoint of conformity to easily available high-output lasers.

As the dye, commercially available dyes, for example, known dyes described in documents such as “DYE HANDBOOK” (edited by Organic Synthetic Chemical Society, published in 1970) may be utilized. Specific examples of the dye include azo dyes, metal complex salt azo dyes, pyrazolone azo dyes, naphthoquinone dyes, anthraquinone dyes, phthalocycnine dyes, carbonium dyes, quinoneimine dyes, methine dyes, cyanine dyes, squalillium dyes, pyrylium salts, metal thiolate complexes, oxonol dyes, diimmonium dyes, aminium dyes and croconium dyes.

Preferable examples of the dye may include cyanine dyes described in, for example, JP-A Nos. 58-125246, 59-84356, 59-202829 and 60-78787, methine dyes described in, for example, JP-A Nos. 58-173696, 58-181690 and 58-194595, naphthoquinone dyes described in, for example, JP-A Nos. 58-112793, 58-224793, 59-48187, 59-73996, 60-52940 and 60-63744, squalillium dyes described in, for example, JP-A No. 58-112792 and cyanine dyes described in U.K. Patent No. 434,875.

A near-infrared absorbing sensitizer described in U.S. Pat. No. 5,156,938 is also preferably used. Substituted arylbenzo(thio)pyrylium salts described in U.S. Pat. No. 3,881,924, trimethinethiapyrylium salts described in JP-A No. 57-142645 (U.S. Pat. No. 4,327,169), pyrylium type compounds described in JP-A Nos. 58-181051, 58-220143, 59-41363, 59-84248, 59-84249, 59-146063 and 59-14606, cyanine dyes described in JP-A No. 59-216146, pentamethinethiopyrylium salts described in U.S. Pat. No. 4,283,475 and pyrylium compounds disclosed in Japanese Patent Application Publication (JP-B) Nos. 05-13514 and 05-19702 are also preferably used.

Also, other preferable examples of the dye may include near-infrared absorbing dyes described as the formulae (I) and (II) in U.S. Pat. No. 4,756,993.

Particularly preferable examples among these dyes include cyanine dyes, phthalocyanine dyes, oxonol dyes, squalillium dyes, pyrylium salts, thiopyrylium dyes and nickel thiolate complexes. Furthermore, dyes represented by the following formulae (a) to (e) have high light-to-heat conversion efficiency and are therefore preferable. Particularly cyanine dyes represented by the following formula (a) give a high interaction with an alkali-soluble resin, are also superior in stability and economical when used as the resin composition of the invention and are therefore most preferable.
Formula (a)

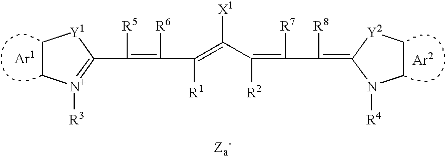

In the formula (a), X¹ represents a hydrogen atom, a halogen atom, —NPh₂, X²-L¹ or a group shown below. Here, X² represents an oxygen atom or a sulfur atom and L¹ represents a hydrocarbon group having 1 to 12 carbon atoms, an aromatic ring having a hetero group, a hydrocarbon group including a heteroatom and having 1 to 12 carbon atoms. Here, the heteroatom indicates N, S, O, a halogen atom or Se.

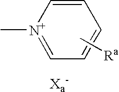

In the above formula, Xₐ⁻ is defined in the same manner as in the case of Zₐ⁻ and R^{a} represents a substituent selected from a hydrogen atom, an alkyl group, an aryl group, a substituted or unsubstituted amino group and a halogen atom.

In the formula (a), R¹ and R² respectively represent a hydrocarbon group having 1 to 12 carbon atoms. R¹ and R² respectively preferably a hydrocarbon group having 2 or more carbon atoms and are particularly preferably combined with each other to form a five-membered or six-membered ring.

Ar¹ and Ar², which may be the same or different, respectively represent an aromatic hydrocarbon group which may have a substituent. Preferable examples of the aromatic hydrocarbon group include a benzene ring and a naphthalene ring. Also, preferable examples of the substituent include a hydrocarbon group having 12 or less carbon atoms, a halogen atom or an alkoxy group having 12 or less carbon atoms.

Y¹ and Y², which may the same or different, respectively represent a sulfur atom or a dialkylmethylene group having 12 or less carbon atoms.

R³ and R⁴, which may be the same or different, represents a hydrocarbon group which has 20 or less carbon atoms and may have a substituent. Preferable examples of the substituent include an alkoxy group having 12 or less carbon atoms, carboxyl group and sulfo group.

R⁵, R⁶, R⁷ and R⁸, which may be the same or different, respectively represent a hydrogen atom or a hydrocarbon group having 12 or less carbon atoms, and are respectively preferably a hydrogen atom in view of availability of raw materials.

Zₐ⁻ represents a counter anion. However, in the case where the cyanine dye represented by the formula (a) has an anionic substituent in its structure and it is unnecessary to neutralize the charge, Zₐ⁻ is unnecessary. Zₐ⁻ is preferably a halogen ion, a perchloric acid ion, a tetrafluoroborate ion, a hexafluorophosphate ion and a sulfonic acid ion and particularly preferably a perchloric acid ion, a hexafluorophosphate ion and an arylsulfonic acid ion from the viewpoint of storage stability of the recording layer coating solution.

Specific examples of the cyanine dye which is represented by the formula (a) and is preferably used in the invention may include those given below and those described in JP-A No. 2001-133969, paragraphs Nos. [0017] to [0019], JP-A No. 2002-40638, paragraphs No. [0012] to [0038] and JP-A No. 2002-23360, paragraphs No. [0012] to [0023].

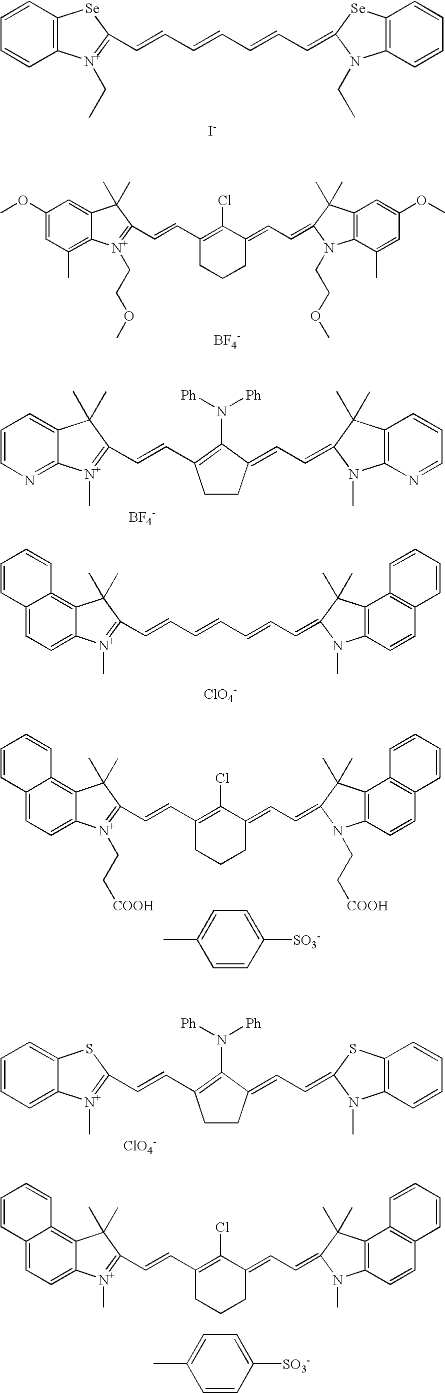

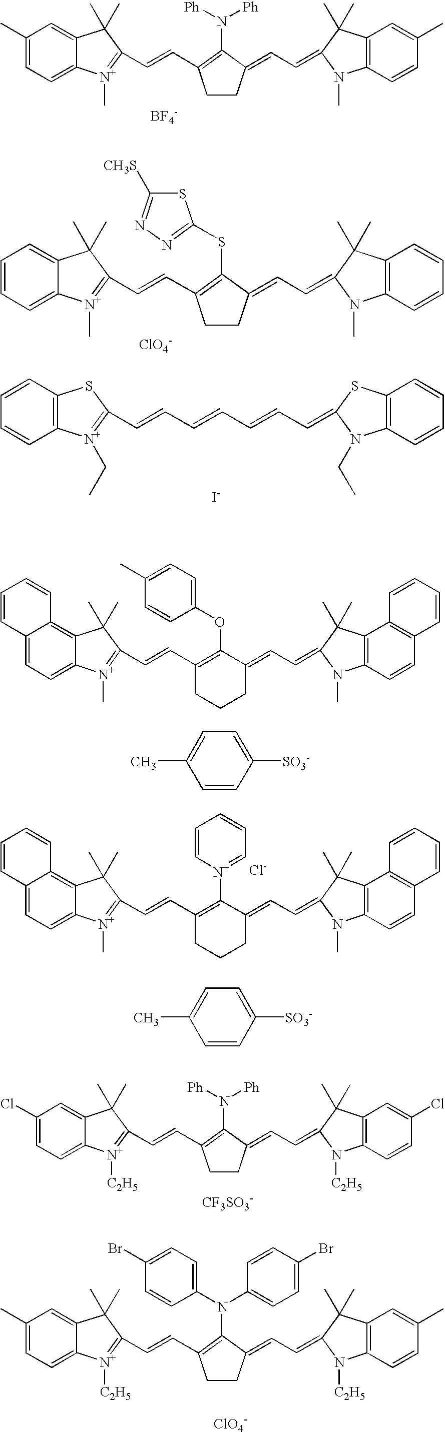

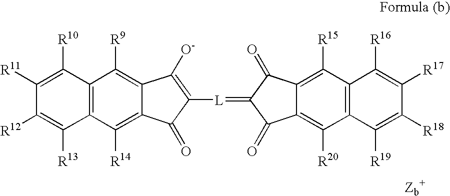

In the formula (b), L represents a methine chain having 7 or more conjugate carbon atoms, wherein the methine chain may have substituents, which may be combined with each other to form a cyclic structure. Z_{b}⁺ represents a counter cation. Preferable examples of the counter cation include ammonium, iodonium, sulfonium, phosphonium, pyridinium and alkali metal cations (Ni⁺, K⁺ and Li⁺).

R⁹ to R¹⁴ and R¹⁵ to R²⁰ respectively represent a hydrogen atom or a substituent selected from a halogen atom, a cyano group, an alkyl group, an aryl group, an alkenyl group, an alkinyl group, a carbonyl group, a thio group, a sulfonyl group, a sulfinyl group and an oxy group and an amino group or a substituent which is a combination of two or three of these groups and may be combined with each other to form a cyclic structure.

Among the compounds represented by the formula (b), those represented by the formula (b) in which L represents a methine chain having 7 conjugate carbon atoms and those represented by the formula (b) in which all of R⁹ to R¹⁴ and R¹⁵ to R²⁰ respectively represent hydrogen atom are preferable from the viewpoint of availability and effect.

Specific examples of the dye represented by the formula (b) which can be preferably used in the invention may include those exemplified below.

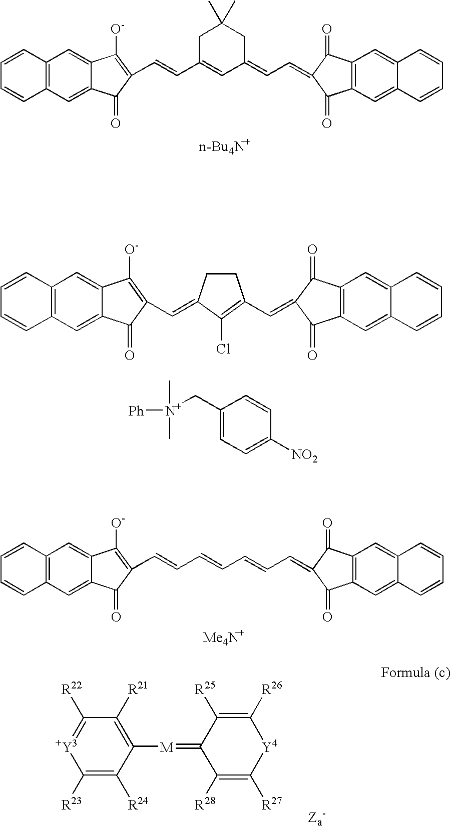

In the formula (c), Y³ and Y⁴ respectively represent an oxygen atom, a sulfur atom, a selenium atom or a tellurium atom. M represents a methine chain having 5 or more conjugate carbon atoms. R²¹ to R²⁴ and R²⁵ to R²⁸, which may be the same or different, respectively represent a hydrogen atom, a halogen atom, a cyano group, an alkyl group, an aryl group, an alkenyl group, an alkinyl group, a carbonyl group, a thio group, a sulfonyl group, a sulfinyl group, an oxy group or an amino group. Also, Zₐ⁻ in the formula represents an anion and has the same meaning as Zₐ⁻ in the formula (a).

Specific examples of the dye represented by the formula (c) which can be preferably used in the invention may include those exemplified below.

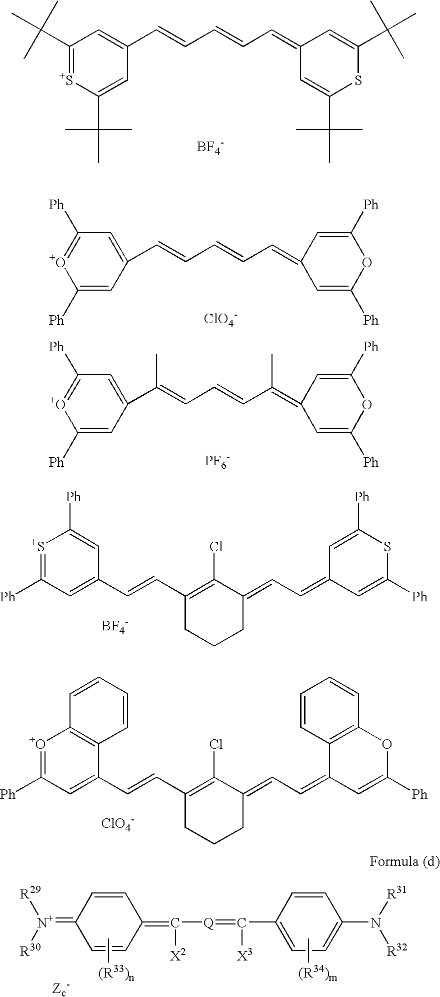

In the formula (d), R²⁹ to R³¹ respectively represent a hydrogen atom, an alkyl group or an aryl group. R³³ and R³⁴ respectively represent an alkyl group, a substituted oxy group or a halogen atom. n and m respectively denote an integer from 0 to 4. R²⁹ and R³⁰or R³¹ and R³² may be combined with each other to form a ring. Also, R²⁹ and/or R³⁰ and R³³ or R³¹ and/or R³² and R³⁴ may be combined with each other to form a ring. Moreover, when R³³ or R³⁴ is present in the plural, R³³s or R³⁴s may be combined among them to form a ring.

X² and X³ respectively represent a hydrogen atom, an alkyl group or an aryl group provided that at least one of X² and X³ represents a hydrogen atom or an alkyl group.

Q represents a trimethine group or a pentamethine group which may have a xubstituent and may form a cyclic structure in combination with a divalent organic group. Z_{c}⁻ represents a counter anion and has the same meaning as Zₐ⁻ in the above formula (a).

Specific examples of the dye represented by the formula (d) which can be preferably used in the invention may include those exemplified below.

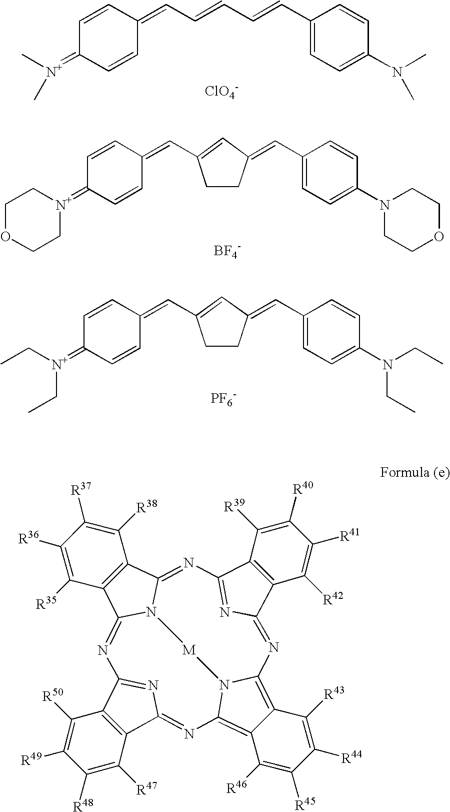

In the formula (e), R³⁵ to R⁵⁰ repectively represent a hydrogen atom, a halogen atom, a cyano group, an alkyl group, a n aryl group, an alkenyl group, an alkinyl group, a hydroxyl group, a carbonyl group, a thio group, a sulfonyl group, a sulfinyl group, an oxy group, an amino group or an onium salt structure which may have a substituent. M represents two hydrogen atoms or a metal atom, a halo-metal group or an oxy metal group. Examples of the metal atoms contained therein include the IA, IIA, IIIB or IVB group atoms in the periodic chart, transition metals of the first, second and third periods and lanthanoids. Among these materials, copper, magnesium, iron, zinc, cobalt, aluminum, titanium and vanadium are preferable.

Specific examples of the dye represented by the formula (e) which can be preferably used in the invention may include those exemplified below.

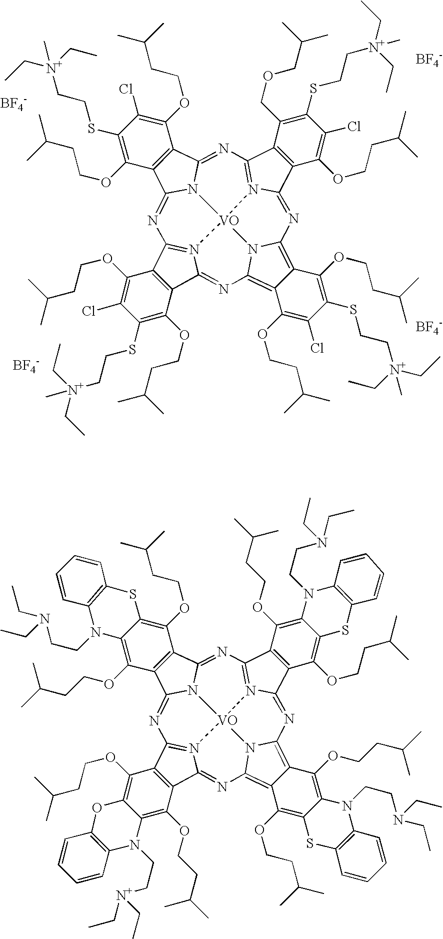

Examples of the pigment to be used as the infrared absorber in the invention include commercially available pigments and pigments described in Color Index (C.I.) Handbook, “Latest Pigment Handbook” (edited by Japanese Pigment Technological Society, published in 1977), “Latest Pigment Applied Technology” (CMC Publishing Co., Ltd., published in 1986) and “Printing Ink Technology” CMC Publishing Co., Ltd., published in 1984).

Examples of these pigments include black pigments, yellow pigments, orange pigments, brown pigments, red pigments, violet pigments, blue pigments, green pigments, fluorescent pigments, metal powder pigments and polymer binder dyes. Specifically, insoluble azo pigments, azo lake pigments, condensed azo pigments, chelate azo pigments, phthalocyanine type pigments, anthraquinone type pigments, perylene and perinone type pigments, thioindigo type pigments, quinacridone type pigments, dioxazine type pigments, isoindolinone type pigments, quinophthalone type pigments, dyeing lake pigments, azine pigments, nitroso pigments, nitro pigments, natural pigments, fluorescent pigments, inorganic pigments, carbon black and the like may be used. Among these pigments, carbon black is preferable.

These pigments may be used either without any surface treatment or with some surface treatment. As the surface treating method, it is considered to use, for example, a method in which the surface is coated with a resin or wax, a method in which a surfactant is stuck to the surface of a pigment or a method in which a reactive material (e.g., a silane coupling agent, epoxy compound and polyisocyanate) is bound with the surface of a pigment. The above surface treating methods are described in “Nature and Application of Metal Soaps” (Saiwai Shobo), “Printing Ink Technology” CMC Publishing Co., Ltd., published in 1984) and “Latest Pigment Applied Technology” (CMC Publishing Co., Ltd., published in 1986).

The particle diameter of the pigment is preferably in a range of 0.01 μm to 10 μm, more preferably in a range of 0.05 μm to 1 μm and particularly preferably in a range of 0.1 μm to 1 μm. When the particle diameter of the pigment is less than 0.01 μm, this is undesirable from the viewpoint of the stability of a dispersion in an image recording layer coating solution whereas when the particle diameter exceeds 10 μm, this is undesirable from the viewpoint of the uniformity of an image recording layer.

As a method of dispersing the pigment, known dispersing technologies used for the production of ink and toners may be used. Examples of a dispersing machine include a ultrasonic dispersing machine, sand mill, attritor, pearl mill, super mill, ball mill, impeller, disperser, KD mill, colloid mill, dynatron, three-roll mill and pressure kneader. The details of these machines are described in “Latest Pigment Apply Technology” (CMC Publishing Co., Ltd., published in 1986).

These pigments or dyes may be added in an amount of 0.01 to 50% by weight and preferably 0.1 to 10% by weight and particularly preferably 0.5 to 10% by weight in the case of a dye and 3.1 to 10% by weight in the case of a pigment based on the total solid in the image recording layer from the viewpoint of sensitivity, the uniformity of the image recording layer and filming characteristics.

These dyes or pigments may be added to the same layer containing other components or to a layer formed separately.

Next explanations will be furnished as to other components which may be compounded when preparing an image recording layer coating composition in the planographic printing plate of the invention.

Various additives may be further combined if necessary in the image recording layer coating composition insofar as the effect of the invention is not impaired. Specifically, for example, cyclic acid anhydrides, phenols and organic acids for improving sensitivity may be added. Also, a printing-out agent for obtaining a visible image just after exposure to light, dyes as an image colorant and other fillers may be added.

Examples of the cyclic acid anhydride include phthalic acid anhydride, tetrahydrophthalic acid anhydride, hexahydrophthalic acid anhydride, 3,6-endoxy-Δ4-tetrahydrophthalic acid anhydride, tetrachlorophthalic acid anhydride, maleic acid anhydride, chloromaleic acid anhydride, α-phenylmaleic acid anhydride, succinic acid anhydride and pyromellitic acid anhydride as described in U.S. Pat. No. 4,115,128. Examples of the phenols include bisphenol A, p-nitrophenol, p-ethoxyphenol, 2,3,4-trihydroxybenzophenone, 4-hydroxybenzophenone, 2,4,4′-trihydroxybenzophenone, 4,4′,4″-trihydroxy-triphenylmethane and 4,4′,3″,4′-tetrahydroxy-3,5,3′,5′-tetramethyltriphenylmethane.

Examples of the organic acids include sulfonic acids, sulfinic acids, alkyl sulfates, phosphonic acids, phosphinic acids, phosphates and carboxylic acids as described in JP-A Nos. 60-88942 and 2-96755. Specific examples of these acids include p-toluenesulfonic acid, dodecylbenzenesulfonic acid, p-toluenesulfinic acid, ethylsulfuric acid, phenylphosphonic acid, phenylphosphinic acid, phenyl phosphate, diphenyl phosphate, benzoic acid, isophthalic acid, adipic acid, p-toluic acid, 3,4-dimethoxybenzoic acid, phthalic acid, terephthalic acid, 1,4-cyclohexene-2,2-dicarboxylic acid, erucic acid, lauric acid, n-undecanoic acid and ascorbic acid.

The proportion of the above cyclic acid anhydrides, phenols and organic acids in the above photosensitive composition is preferably 0.05 to 15% by weight and more preferably 0.1 to 5% by weight.

Examples of the printing-out agent for obtaining a visible image immediately after exposure to light may include combinations of photosensitive compounds which release an acid by exposure to light and organic dyes which form a salt in combination with an acid to change a tone.

Examples of the photosensitive compound which releases an acid by exposure to light may include o-naphthoquinonediazido-4-sulfonic acid halogenides as described in JP-A No. 50-36209; trihalomethyl-2-pyrone and trihalomethyl-s-triazine as described in JP-A No. 53-36223; o-naphthoquinonediazide compounds as described in JP-A No. 55-62444; 2-trihalomethyl-5-aryl-1,3,4-oxadiazole compounds as described in JP-A No. 55-77742; and diazonium salts.

These compounds may be used either singly or as a mixture. The amount of these compounds to be added is preferably in a range of 0.3 to 15% by weight based on the total weight of the composition.

At least one of organic dyes may be added to the image recording layer composition of the planographic printing plate precursor of the invention, which dyes interact with a photodegradation product of a compound which is photo-degraded to generate an acid material, to change its tone.

As such an organic dye, a diphenylmethane type, triarylmethane type, thiazine type, oxazine type, phenazine type, xanthene type, anthraquinone type, iminonaphthoquinone type or azomethine type dye may be used. Specific examples of these dyes include;

Brilliant green, Eosine, Ethyl Violet, Erythrocin B, Methyl Green, Crystal Violet, Basic Fuchsine, Phenolphthalein, 1,3-diphenyltriazine, Alizarin red S, Thymolphthalein, Methyl Violet 2B, Quinaldine Red, Rose Bengale, Thymolsulfophthalein, Xylenol Blue, Methyl Orange, Orange IV, Diphenylthiocarbazone, 2,7-dichlorofluorescein, Paramethyl Red, Congo Red, Benzopurpurin 4B, α-naphthyl Red, Nile Blue 2B, Nile Blue A, Phenacetarine, Methyl Violet, Malachite Green, Parafuchsine, Oil Blue #603 (manufactured by Orient Chemical Industries, Ltd.), Oil Pink #312 (manufactured by Orient Chemical Industries, Ltd.), Oil Red 5B (manufactured by Orient Chemical Industries, Ltd.), Oil Scarlet #308 (manufactured by Orient Chemical Industries, Ltd.), Oil Red OG (manufactured by Orient Chemical Industries, Ltd.), Oil Red RR (manufactured by Orient Chemical Industries, Ltd.), Oil Green #502 (manufactured by Orient Chemical Industries, Ltd.), Spiron Red BEH Special (manufactured by Hodogaya Chemical Co., Ltd.), Victoria Pure Blue BOH (manufactured by Hodogaya Chemical Co., Ltd.);

Patent Pure Blue (manufactured by Sumitomo Mikuni Kagaku Kogyo K. K.), Sudan Blue II (manufactured by BASF), m-cresol Purple, Cresol Red, Rhodamine B, Rhodamine 6G, First Acid Violet R, Sulforhodamine B, Auramine, 4-p-diethylaminophenyliminonaphthoquinone, 2-carboxyanilino-4-p-diethylaminophenyliminonaphthoquinone, 2-carbostearylamino-4-p-dihydroxyethyl-amino-phenyliminonaphthoquinone, p-methoxybenzoyl-p′-diethylamino-o′-methylphenyliminoacetoanilide, cyano-p-diethylaminophenyliminoacetoanilide, 1-phenyl-3-methyl-4-p-diethylaminophenylimino-5-pyrazolone and 1-βi-naphthyl-4-p-diethylaminophenylimino-5-pyrazolone.

A particularly preferable one as the organic dye is a triarylmethane type dye. Among triarylmethane type dyes, those having a sulfonic acid compound as a counter anion as disclosed in JP-A No. 62-2932471 and Japanese Patent No. 2969021 are particularly useful.

These dyes may be used either singly or by mixing two or more. The amount of these dyes to be added is preferably 0.3 to 15% by weight based on the total weight of the image recording layer composition. Also, other dyes or pigments may be combined if necessary and the amount of these other dyes or pigments to be used is 70% by weight or less and more preferably 50% by weight or less based on the total weight of the dyes and pigments.

The image recording composition may be formulated with, besides the above components, various additives corresponding to various objects. Examples of these various additives include various resins having a hydrophobic group for improving the inking property of an image, for example, an octylphenol.formaldehyde resin, t-butylphenol formaldehyde resin, t-butylphenol benzaldehyde resin, rosin modified novolak resin and o-naphthoquinone diazidosulfonate of the modified novolak resin; and plasticizers for improving the flexibility of a coating layer, for example, dibutyl phthalate, dioctyl phthalate, butyl glycolate, tricresyl phosphate and dioctyl adipate. The amount of these additives to be added is preferably 0.01 to 30% by weight based on the total weight of the composition.

Moreover, known resins for more improving the abrasion resistance of a coating layer may be added to the composition. Examples of these resins include polyvinylacetal resins, polyurethane resins, epoxy resins, vinyl chloride resins, nylon, polyester resins and acryl resins. These resins may be used either independently or by mixing two or more. The amount of these resins to be added is preferably 2 to 40% by weight based on the total weight of the composition.

Also, a nonionic surfactant as described in JP-A Nos. 62-251740 and 4-68355 and an amphoteric surfactant as described in JP-A Nos. 59-121044 and 4-13149 may be added to the composition to enlarge the development latitude.

Specific examples of the nonionic surfactant include sorbitan tristearate, sorbitan monopalmitate, sorbitan trioleate, stearic acid monoglyceride, polyoxyethylene sorbitanmonooleate and polyoxyethylene nonylphenyl ether.

Specific examples of the amphoteric surfactant include an alkyldi(aminoethyl)glycine, alkylpolyaminoethylglycine hydrochloride, Amorgen K (trade name, manufactured by Dai-ichi Kogyo Seiyaku Co., Ltd., N-tetradecyl-N,N-betaine type), 2-alkyl-N-carboxyethyl-N-hydroxyethylimidazoliniumbetaine and Rebon 15 (trade name, manufactured by Sanyo Chemical Industries, Ltd., alkylimidazoline type).

The proportion of the nonionic surfactant and amphoteric surfactant in the image recording layer composition is preferably 0.05 to 15% by weight and more preferably 0.1 to 5% by weight.

A surfactant that improves the quality of a coating layer, for example, a fluorine type surfactant as described in JP-A No. 62-170950 may be added to the composition.

The amount of the surfactant to be added is preferably 0.001 to 1.0% by weight and more preferably 0.005 to 0.5% by weight.

A yellow type dye preferably having the characteristics that the absorbance for 417 nm light is 70% or more of that for 436 nm light may be added.

(Production of a Planographic Printing Plate Precursor)

The planographic printing plate precursor of the invention can be produced by dissolving or dispersing each components of the aforementioned positive type image recording layer and components for a coating solution for a desired layer in a solvent and then applying the obtained solution to a proper substrate, followed by drying.

As the coating solvent used for the dissolution and application of the image recording layer according to the invention, any of known and common organic solvents may be used.

A solvent having a boiling point range of 40° C. to 200° C. and particularly 60° C. to 160° C. is preferably selected in view of an advantage when the coating layer is dried.

As the organic solvent, alcohols such as methyl alcohol, ethyl alcohol, n- or iso-propyl alcohol, n- or iso-butyl alcohol and diacetone alcohol, ketones such as acetone, methyl ethyl ketone, methyl propyl ketone, methyl butyl ketone, methyl amyl ketone, methyl hexyl ketone, diethyl ketone, diisobutyl ketone, cyclohexanone and methylcyclohexanone and acetylacetone, hydrocarbons such as benzene, toluene, xylene, cyclohexanone and methoxybenzene, acetates such as ethyl acetate, n- or iso-propyl acetate, n- or iso-butyl acetate, ethylbutyl acetate and hexyl acetate, halides such as methylene dichloride, ethylene dichloride and monochlorobenzene, ethers such as isopropyl ether, n-butyl ether, dioxane, dimethyldioxane and tetrahydrofuran;

polyhydric alcohols and their derivatives such as ethylene glycol, methyl cellosolve, methyl cellosolve acetate, ethyl cellosolve, diethyl cellosolve, cellosolve acetate, butyl cellosolve, butyl cellosolve acetate, methoxymethoxy ethanol, diethylene glycol monomethyl ether, diethylene glycol dimethyl ether, diethylene glycol methylethyl ether, diethylene glycol diethyl ether, propylene glycol, propylene glycol monomethyl ether, propylene glycol monomethyl ether acetate, propylene glycol monoethyl ether, propylene glycol monoethyl ether acetate, propylene glycol monobutyl ether and 3-methyl-3-methoxybutanol and special solvents such as dimethyl sulfoxide and N,N-dimethylformamide may be preferably used either singly or by mixing two or more. The concentration of a solid in the composition to be applied is made to be 2 to 50% by weight.

As methods of applying each coating solution for the image recording layer in the photosensitive planographic printing plate of the invention, various known methods may be used. Examples of these methods include methods such as roll coating, dip coating, air knife coating, gravure coating, gravure offset coating, hopper coating, blade coating, wire doctor coating and spray coating.

The amount of the image recording layer to be applied to the substrate of the planographic printing plate precursor of the invention is preferably 0.1 to 5.0 g/m² and more preferably 0.3 to 4.0 g/m² as a dry weight. Generally, sensitivity is improved but layer strength is dropped with a decreased coating amount. Also, as the coating amount is larger, sensitivity tends to be dropped but layer strength is improved and a printing plate having high printing durability is obtained when the image recording layer is used for a printing plate.

(Substrate)

As the substrate used in the planographic printing plate precursor, any material may be used without any particular limitation insofar as it is a dimensionally stable plate material and those which have been used so far as the substrate of printing plates may be preferably used in the invention.

Examples of the substrate material include paper, paper on which plastics (e.g., a polyethylene, polypropylene and polystyrene) are laminated, metal plates such as aluminum (including an aluminum alloy), zinc, iron and copper plates, plastic films such as cellulose diacetate, cellulose triacetate, cellulose propionate, cellulose butyrate, cellulose butyrate acetate, cellulose nitrate, polyethylene terephthalate, polyethylene, polystyrene, polypropylene, polycarbonate and polyvinylacetal and paper or plastic films on which a metal such as those mentioned above is laminated or deposited. Particularly, an aluminum plate is preferable.

The aluminum plates include a pure aluminum plate and aluminum alloy plates. As the aluminum alloys, various materials may be used. For example, alloys of metals such as silicon, copper, manganese, magnesium, chromium, zinc, lead, bismuth or nickel and aluminum are used. These compositions contain impurities to the extent that they may be neglected in addition to a little amount of iron and titanium.

The substrate is surface-treated if necessary. The surface of the substrate of the planographic printing plate precursor of the invention is preferably processed by hydrophilic treatment. Also, in the case of a substrate having a metal surface and particularly an aluminum surface, the substrate is preferably processed by pebbling treatment, dipping treatment in an aqueous solution of sodium silicate, potassium fluorozirconate or phosphate or anodic oxidation treatment.

Also, an aluminum plate obtained by pebbling and then by dipping it in an aqueous sodium silicate solution as described in U.S. Pat. No. 2,714,066 and an aluminum plate obtained by anodic oxidation treatment and then by dipping it in an aqueous alkali silicate solution as described in U.S. Pat. No. 3,181,461 are preferably used.

The above anodic oxidation treatment is carried out by flowing current by using an aluminum plate as an anode in an electrolyte prepared by using aqueous solutions or nonaqueous solutions of inorganic acids such as phosphoric acid, chromic acid, sulfuric acid and boric acid or organic acids such as oxalic acid and sulfamic acid or salts of these acids either singly or in combinations of two or more.

Silicate electrodeposition as described in U.S. Pat. No. 3,658,662 is also effective. These hydrophilic treatments are carried out not only for making the surface of the substrate hydrophilic but also for preventing a harmful reaction with the photosensitive composition to be provided on the surface of the substrate and for improving adhesion to the image recording layer. The pretreatment of the surface of aluminum may be performed to remove roll oil from the surface and to expose a pure aluminum surface if necessary prior to the pebbling of the aluminum plate.

A solvent such as trichlene, a surfactant and the like are used for the former treatment. Also, a method of using an alkali etchant such as sodium hydroxide and potassium hydroxide is widely adopted for the latter treatment.

As the pebbling method, mechanical methods, chemical methods and electrochemical methods are all effective. Examples of the mechanical method include a ball abrasive method, blast abrasive method and brush abrasive method in which a water dispersion slurry of an abrasive such as pumice is applied to the surface to rub the surface using a nylon brush.

As the chemical method, a method as described in JP-A No. 54-31187 is preferred wherein the aluminum plate is dipped in an aqueous saturated solution of an aluminum salt of a mineral acid.

As the electrochemical method, a method in which the aluminum plate is subjected to a.c. electrolysis in an acidic electrolyte such as hydrochloric acid, nitric acid or a combination of these acids is preferable.

Among these surface roughening methods, particularly a surface roughening method combining mechanical surface roughening treatment with electrochemical surface roughening treatment as described in JP-A No. 55-137993 is preferable because the adhesion of a fat-sensitive image to the substrate is strong.

The pebbling as mentioned above is preferably carried out such that the center line surface roughness (Ra) of the surface of the aluminum plate falls in a range of 0.3 to 1.0 μm. The aluminum plate pebbled in this manner is washed with water and etched chemically if necessary.

The etchant is selected from aqueous solutions of a base or an acid which generally dissolves aluminum. In this case, the etchant must not be a type forming a film which is different from an aluminum film and is derived from the components of the etchant on the etched surface.

Preferable examples of the etchant include basic materials such as sodium hydroxide, potassium hydroxide, trisodium phosphate, disodium phosphate, tripotassium phosphate and dipotassium phosphate; and acidic materials such as sulfuric acid, persulfuric acid, phosphoric acid and hydrochloric acid and salts of these materials. Salts of metals, such as zinc, chromium, cobalt, nickel and copper, having lower ionization tendency than aluminum form an unnecessary film on the etched surface and are therefore undesirable.

As to working concentration and temperature of these etchants, the etching is even more preferably carried out such that the rate of dissolution of aluminum or an alloy to be used is 0.3 g to 40 g/m² per unit dipping time (one minute). However, a dissolution rate above or below the above range is allowed.

The etching is carried out by dipping the aluminum plate in the above etchant or by applying the etchant to the aluminum plate and is preferably carried out such that the amount of etching falls in a range of 0.5 to 10 g/m².

As the above etchant, it is preferable to use an aqueous solution of a base because of the feature that the etching speed is high. In this case, a smut is generated and therefore the aluminum plate is subjected to desmutting treatment in usual.

As the acid used for desmutting treatment, nitric acid, sulfuric acid, phosphoric acid, chromic acid, hydrofluoric acid, borohydrofluoric acid and the like are used. The aluminum plate which has been etched is washed with water and is subjected to anodic oxidation if necessary. The anodic oxidation can be carried out by a method conventionally used in this field.

Specifically, when a.c. or d.c. current is flowed through aluminum in an aqueous solution or non-aqueous solution of sulfuric acid, phosphoric acid, chromic acid, oxalic acid, sulfamic acid, benzenesulfonic acid and the like or a combination of two or more of these acids, an anodic oxide film can be formed on the surface of the aluminum substrate.

Although the process condition of the anodic oxidation cannot be specified as a whole because it varies depending on the type of electrolyte, the condition is properly in the following ranges in general: concentration of an electrolytic solution: 1 to 80% by mass, solution temperature: 5 to 70° C., current density: 0.5 to 60 A/dm², voltage: 1 to 100 V and electrolytic time: 30 seconds to 50 minutes.

Among these anodic oxidation treatments, particularly, a method in which anodic oxidation treatment is carried out at a high current density in sulfuric acid as described in U.K. Patent No. 1,412,768 and a method in which phosphoric acid is used as an electrolytic bath to carry out anodic oxidation as described in U.S. Pat. No. 3,511,661 are preferable.

The aluminum plate which has been subjected to surface roughening treatment and anodic oxidation treatment may be subjected to hydrophilic treatment if necessary. Preferable examples of the method of hydrophilic treatment include methods using an alkali metal silicate, for example, an aqueous sodium silicate solution as disclosed in U.S. Pat. Nos. 2,714,066 and 3,181,461, methods using potassium flurozirconate as disclosed in JP-B No. 36-22063 and methods in which a polyvinylphosphonic acid is used for treating as disclosed in U.S. Pat. No. 4,153,461.

Organic undercoating layer; it is preferable to provide the photosensitive planographic printing plate of the invention with an organic undercoating layer to decrease a residual film in the non-image part.

As the organic compound to be used in the organic undercoating layer, a preferable one is selected from phosphonic acids having an amino group such as carboxymethyl cellulose, dextrin, gum arabic and 2-aminoethylphosphonic acid, organic phosphonic acids, such as phenylphosphonic acid, naphthylphosphonic acid, alkylphosphonic acid, glycerophosphonic acid, methylenediphosphonic acid and ethylenediphosphonic acid, which may have a substituent, organic phosphoric acids, such as phenylphosphoric acid, naphthylphosphoric acid, alkylphosphoric acid and glycerophosphoric acid, which may have a substituent, organic phosphinic acids, such as phenylphosphinic acid, naphthylphosphinic acid, alkylphosphinic acid and glycerophosphinic acid, which may have a substituent, amino acids such as glycine and β-alanine and amine hydrochlorides having a hydroxyl group such as hydrochlorides of triethanolamine. These compounds may be used in combinations of two or more.

Also, the organic undercoating layer preferably contains a compound having an onium group. The compounds having an onium group are described in JP-A Nos. 2000-10292 and 2000-108538.

Other than the above, it is possible to use at least one compound selected from a polymer compound group having a structural unit represented by a poly(p-vinylbenzoic acid) in each molecule. More specific examples of the compound include a copolymer of p-vinylbenzoic acid and vinylbenzyltriethylammonium salt and a copolymer of p-vinylbenzoic acid and vinylbenzyltrimethylammonium chloride.

This organic undercoating layer may be disposed in the following method. Namely, there are a method in which a solution prepared by dissolving the above organic compound in water or an organic solvent such as methanol, ethanol and methyl ethyl ketone or a mixed solvent of them is applied to an aluminum plate and dried to form the organic undercoating layer and a method in which an aluminum plate is dipped in a solution prepared by dissolving the above organic compound in water or an organic solvent such as methanol, ethanol and methyl ethyl ketone or a mixed solvent of them to adsorb the organic compound and then washed with water or the like, followed by drying to provide an organic undercoating layer.

In the former method, a solution containing the organic compound in a concentration of 0.005 to 10% by weight may be applied using various methods. For example, any of bar coater coating, rotary coating, spray coating and curtain coating may be used.

In the latter method, the concentration of the solution is 0.01 to 20% by weight and preferably 0.05 to 5% by weight, the dipping temperature is 20 to 90° C. and preferably 25 to 50° C. and the dipping time is 0.1 seconds to 20 minutes and preferably 2 seconds to 1 minute.

The solution used here may be used in a pH range from 1 to 12 by adjusting the pH using basic materials such as ammonia, triethylamine and potassium hydroxide and acidic materials such as hydrochloric acid and phosphoric acid. Also, a yellow dye may be added to improve the tone reproducibility of the planographic printing plate. A compound represented by the following formula (a) may be further added:
(HO)ₓ—R⁵—(COOH)_{y} Formula (a)
wherein R⁵ represents an arylene group having 14 or less carbon atoms and x and y respectively denote an integer from 1 to 3. Specific examples of the compound represented by the formula (a) include 3-hydroxybenzoic acid, 4-hydroxybenzoic acid, salicylic acid, 1-hydroxy-2-naphthoic acid, 2-hydroxy-1-naphthoic acid, 2-hydroxy-3-naphthoic acid, 2,4-dihydroxybenzoic acid and 10-hydroxy-9-anthracenecarboxylic acid. The amount of the organic undercoating layer after dried is properly 1 to 100 mg/M², preferably 2 to 70 mg/m². When the coating amount is less than 2 mg/m², only insufficient printing durability is obtained. When the coating mount exceeds 100 mg/M², the same result is also obtained.

Backcoat: a backcoat layer is formed on the backside of the substrate if necessary. As such a backcoat, a coating layer constituted of a metal oxide obtained by hydrolyzing or polymerization-condensing an organic high-molecular compound as described in JP-A No. 5-45885 or an organic or inorganic metal compound as described in JP-A No. 6-35174 is preferably used. Among these coating layers, coating layers constituted of a metal oxide obtained from alkoxy compounds of silicon such as Si(OCH₃)₄, Si(OC₂H₅)₄, Si(OC₃H₇)₄ and Si(OC₄H₉)₄ are particularly preferable because these alkoxy compounds are inexpensive and easily available and the coating layer of a metal oxide obtained therefrom is superior in resistance to developer.

The planographic printing plate precursor produced in the above-described manner is usually subjected to image-wise exposure and developing treatment. As a light source of active rays used in the image-wise exposure, a light source having an emission wavelength in the near-infrared to infrared region is preferable and a solid laser or semiconductor laser is particularly preferable.

A developer which can be applied to the developing of the planographic printing plate of the invention is a developer having a pH ranging from 9.0 to 14.0 and preferably from 12.0 to 13.5. As the developer (hereinafter called a developer including a replenishing solution), a conventionally known aqueous alkali solution may be used.

Examples of the developer include inorganic alkali salts such as sodium silicate, potassium silicate, tertiary sodium phosphate, tertiary potassium phosphate, tertiary ammonium phosphate, secondary sodium phosphate, secondary potassium phosphate, secondary ammonium phosphate, sodium carbonate, potassium carbonate, ammonium carbonate, sodium bicarbonate, potassium bicarbonate, ammonium bicarbonate, sodium borate, potassium borate, ammonium borate, sodium hydroxide, ammonium hydroxide, potassium hydroxide and lithium hydroxide. Also, organic alkali agents such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine and pyridine are exemplified.

These alkali agents are used either singly or in combinations of two or more.

Among the aforementioned aqueous alkali solutions, one of developers producing the effect of the invention is a so-called “silicate developer” containing an alkali silicate as a base or an alkali silicate prepared by mixing a silicon compound in a base and having a pH of 12 or more. Another preferable developer is a so-called “non-silicate developer” which contains no alkali silicate but contains a non-reducing sugar (an organic compound having buffer action) and a base.

In the former case, the developing ability of the aqueous solution of the alkali metal silicate can be controlled by the ratio (generally indicated by the ratio by mol of [SiO₂]/[M₂O] of silicon oxide (SiO₂) to an alkali metal oxide (M₂O) and the concentrations of these components.

For example, an aqueous solution of sodium silicate in which the molar ratio of SiO₂/Na₂O is 1.0 to 1.5 (namely, [SiO₂]/[Na₂O] is 1.0 to 1.5) and the content of SiO₂ is 1 to 4% by weight as disclosed in JP-A No. 54-62004 and an aqueous alkali metal silicate solution in which [SiO₂]/[M] is 0.5 to 0.75 (namely, [SiO₂]/[M₂O] is 1.0 to 1.5), the concentration of SiO₂ is 1 to 4% by weight and the developer contains at least 20% of potassium based on the gram atoms of all alkali metals present therein as disclosed in JP-B No. 57-7427 are preferably used.

The so-called “non-silicate developer” which contains no alkali silicate but contains a non-reducing sugar and a base is also preferably applied to the developing of the planographic printing plate material of the invention. When the planographic printing material is developed using this developer, the surface of the image recording layer is not deteriorated and the sticking ability of the image recording layer can be kept in a good state.

This developer contains, as its major components, at least one compound selected from non-reducing sugars and at least one base and preferably has a pH range of 9.0 to 13.5.

Such a non-reducing sugar is sugars which have neither a free aldehyde group nor ketone group and do not exhibit reducibility and is divided into a trehalose type oligosaccharide in which reducing groups are combined among them, a glycoside in which a reducing group of sugars and non-sugars are combined with each other and sugar alcohols obtained by hydrogenating sugars to reduce. These sugars are all used preferably.

Examples of the trehalose type oligosaccharide include saccharose and trehalose and examples of the glycoside include an alkyl glycoside, phenol glycoside and mustard oil glycoside.

Also, examples of the sugar alcohols include D,L-arabitol, ribitol, xylitol, D,L-sorbitol, D,L-mannitol, D,L-iditol, D,L-talitol, Zricit and Arozrcit. Further, maltitol obtained by hydrogenating disaccharide and a reduced form (reduced starch syrup) obtained by hydrogenating oligosaccharide are preferably used.

Among these sugars, sugar alcohols and saccharose are particularly preferable non-reducing sugars and particularly D-sorbitol, saccharose and reduced starch syrup are preferable because these materials each have a buffer action in a moderate pH range and are available at a low cost.

These non-reducing sugars may be used either singly or in combinations of two or more. The proportion of the non-reducing sugar in the developer is preferably 0.1 to 30% by weight and more preferably 1 to 20% by weight.

As the base to be combined with the non-reducing sugar, a conventionally known alkali agent may be used. Examples of the base include inorganic alkali agents such as sodium hydroxide, potassium hydroxide, lithium hydroxide, trisodium phosphate, tripotassium phosphate, triammonium phosphate, disodium phosphate, dipotassium phosphate, diammonium phosphate, sodium carbonate, potassium carbonate, ammonium carbonate, sodium bicarbonate, potassium bicarbonate, ammonium bicarbonate, sodium borate, potassium borate and ammonium borate.

Also, organic alkali agents such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine and pyridine are used.

These alkali agents may be used either singly or in combinations of two or more. Among these agents, sodium hydroxide and potassium hydroxide are preferable. This reason is that the pH of the developer can be controlled in a wide pH range by controlling the ratio by weight of these agents to the non-reducing sugar. Also, trisodium phosphate, tripotassium phosphate, sodium carbonate and potassium carbonate or the like itself has a buffer action and is therefore preferable.

These alkali agents are added such that the pH of the developer falls in a range of 9.0 to 13.5. Specifically, the amount of these alkali agents is determined by a desired pH and the type and amount of the non-reducing sugar. The pH is more preferably in a range of 10.0 to 13.2.

An alkaline buffer solution constituted of a weak acid other than sugars and a strong base may be combined in the developer. As the weak acid to be used as the buffer solution, one having a dissociation constant (pKa) of 10.0 to 13.2 is preferable.

Among these weak acids, sulfosalicylic acid and salicylic acid are preferable. As the base to be combined with these weak acids, sodium hydroxide, ammonium hydroxide, potassium hydroxide and lithium hydroxide are preferably used. These alkali agents are used either singly or in combinations of two or more. The aforementioned various alkali agents are used by controlling the pH within desirable range by means of concentration and combination.

Various surfactants and organic solvents may be added to the developer, if necessary, for the purpose of promoting developing ability, dispersing a developing residue and improving the affinity of the printing plate image part to ink. Preferable examples of the surfactant include anionic, cationic, nonionic or amphoteric surfactants.

The surfactant is more preferably fluorine type surfactants containing a perfluoroalkyl group in their molecules.

Examples of the fluorine type surfactant include anionic surfactants such as perfluoroalkyl carboxylates, perfluoroalkylsulfonates and perfluoroalkyl phosphates, amphoteric surfactants such as perfluoroalkylbetaine, cationic surfactants such as perfluoroalkyltrimethylammonium salts and nonionic surfactants such as perfluoroalkylamine oxide, perfluoroalkylethylene oxide adducts, oligomers containing a perfluoroalkyl group and a hydrophilic group, oligomers containing a perfluoroalkyl group and a lipophilic group, oligomers containing a perfluoroalkyl group, a hydrophilic group and a lipophilic group and urethane containing a perfluoroalkyl group and a lipophilic group.

The above surfactants may be used either singly or in combinations of two or more and added to the developer in an amount ranging from 0.001 to 10% by weight and more preferably 0.01 to 5% by weight.

The photosensitive planographic printing plate developed using the developer having such a composition is subjected after-treatment performed using rinsing water, a rinsing solution containing surfactants and the like and a finisher or a protective gum solution containing gum arabic and a starch derivative as major components. For the after-treatment of the photosensitive planographic printing plate of the invention, these treatments are used in various combinations.

In plate-making and printing fields in recent years, an automatic developing machine for PS plates has been widely used for rationalization and standardization of plate-making works. This automatic developing machine usually consists of a developing section and an aftertreating section, comprising a unit for carrying a PS plate, vessels for each processing solution and a spraying unit, wherein each processing solution which is pumped up is sprayed from a spray nozzle while carrying the exposed PS plate horizontally to carry out developing treatment.

Also, a method has been known recently in which a PS plate is carried by an in-liquid guide roll with dipping it in a processing solution vessel filled with a processing solution. Also, a method has been known in which a fixed and small amount of rinsing water is supplied to the surface of a plate to rinse after the plate is developed and the waste water is reused as water for diluting an undiluted solution of a developer.

In such an automatic treatment, the treatment may be carried out with supplying a replenishing solution to each processing solution corresponding to throughput and operation time. Also, a so-called non-returnable treating system may be applied in which a substantially unused process solution is used to carry out treatment. The planographic printing plate obtained by such treatments is placed in an offset printer and used for printing a number of copies.

### EXAMPLES

The present invention will be explained by way of examples, which, however, are not intended to restrict the scope of the invention.

(Production of a Substrate)

An aluminum plate (JIS-A-1050) 0.3 mm in thickness was used and treated by combining the following steps to make substrates A, B, C and D.

(a) Mechanical Surface Roughening Treatment

Mechanical surface roughening treatment was carried out by a rotating roller-like nylon brush while supplying a suspension of an abrasive agent (pumice) having a specific gravity of 1.12 and water as an abrasive slurry solution to the surface of the aluminum plate. The average particle diameter of the abrasive agent was 8 μm and the maximum particle diameter of the abrasive agent was 50 μm. The material of the nylon brush was 6·10 nylon wherein the hair length was 50 mm and the diameter of the hair was 0.3 mm. The nylon brush was obtained by opening holes in a stainless cylinder having a diameter of 300 mm and by transplanting hairs densely. Three rotary brushes were used. The distance between two support rollers (diameter: 200 mm) under the brush was 300 mm. The brush roller was pressed to the aluminum plate until the load at the driving motor was increased to a load higher by 7 kW than that before it was pressed to the aluminum plate. The direction of the rotation of the brush was the same as the direction of the movement of the aluminum plate. The number of rotations of the brush was 200 rpm.

(b) Alkali Etching Treatment

The aluminum plate obtained above was subjected to etching treatment by spraying a 70° C. aqueous NaOH solution (concentration: 26% by weight, aluminum ion concentration: 6.5% by weight) to etch 6 g/m² of the aluminum plate, followed by washing with water by spraying.

(c) Desmutting Treatment

Desmutting treatment was carried out using an aqueous 1% by weight nitric acid solution (containing 0.5% by weight of aluminum ions) kept at 30° C. by spraying, followed by washing with water by spraying. As the aqueous nitric acid solution used in the desmutting treatment, a waste solution obtained in a step of carrying out electrochemical surface roughening treatment using a.c. current in an aqueous nitric acid solution was used.

(d) Electrochemical Surface Roughening Treatment

Electrochemical surface roughening treatment was continuously carried out using an a.c. voltage of 60 Hz. The electrolytic solution used at this time was an aqueous solution containing 10.5 g/L of nitric acid (including 5 g/L of aluminum ions) and the temperature of this electrolytic solution was 50° C. The a.c. power source had the waveform in which the time TP required for current value to reach a peak from 0 was 0.8 msec and the duty ratio was 1:1, and trapezoidal rectangular wave a.c. current was used to carry out electrochemical surface roughening treatment using a carbon electrode as a counter electrode. As the auxiliary anode, ferrite was used. The electrolytic vessel used here was a radial cell type.

The current density was 30 A/dm² as a peak current, and the quantity of electricity was 220 C/dm² as the total quantity of electricity when the aluminum plate was an anode. 5% of the current flowing from the power source was supplied separately to the auxiliary electrode.

Thereafter, the aluminum plate was washed with water by spraying.

(e) Alkali Etching Treatment

The aluminum plate was subjected to etching treatment carried out at 32° C. using 26% by weight of caustic soda and 6.5% by weight of aluminum ions by spraying to etch the aluminum plate in an amount of 0.20 g/m² to remove the smut component primarily containing aluminum hydroxide generated during the foregoing electrochemical surface roughening treatment using a.c. current, and also to etch the edge portion of the produced pit to thereby round the edge portion. Then, the aluminum plate was washed with water by spraying.

(f) Desmutting Treatment

An aqueous 15% by weight nitric acid solution (including 4.5% by weight of aluminum ions) was used to carry out desmutting treatment at 30° C. by spraying, followed by washing with water by spraying. As the aqueous nitric acid solution used in the desmutting treatment, a waste solution used in a step of carrying out electrochemical surface roughening treatment using a.c. current in an aqueous nitric acid solution was used.

(g) Electrochemical Surface Roughening Treatment

Electrochemical surface roughening treatment was continuously carried out using an a.c. voltage of 60 Hz. The electrolytic solution used at this time was an aqueous solution containing 7.5 g/L of hydrochloric acid (including 5 g/L of aluminum ions) and the temperature of this electrolytic solution was 35° C. The a.c. power source had a trapezoidal rectangular waveform to carry out electrochemical surface roughening treatment using a carbon electrode as a counter electrode. As the auxiliary anode, ferrite was used. The electrolytic vessel used was a radial cell type.

The current density was 25 A/dm² as a peak current and the quantity of electricity was 50 C/dm² as the total quantity of electricity when the aluminum plate was an anode.

Then the aluminum plate was washed with water by spraying.

(h) Alkali Etching Treatment

The aluminum plate was subjected to etching treatment carried out at 32° C. using a solution containing 26% by weight of caustic soda and 6.5% by weight of aluminum ions by spraying to etch the aluminum plate in an amount of 0.10 g/m² to remove the smut component primarily containing aluminum hydroxide generated when performing foregoing electrochemical surface roughening treatment using a.c. current, and also to etch the edge part of the pit produced to thereby round the edge part. Then, the aluminum plate was washed with water by spraying.

(i) Desmutting Treatment

An aqueous 25% by weight sulfuric acid solution (including 0.5% by weight of aluminum ions) was used to carry out desmutting treatment at 60° C. by spraying, followed by washing with water by spraying.

(j) Anodic Oxidation Treatment

As the electrolytic solution, sulfuric acid was used. All the electrolytic solutions contained 170 g/L of sulfuric acid (including 0.5% by weight of aluminum ions) and were used at 43° C. Then, the substrate was washed with water by spraying.

The current densities were respectively about 30A/dm². The amount of the final oxide film was 2.7 g/m².

<Substrate A>

The above steps (a) to 0) were carried out in this order such that the quantity of etching was 3.4 g/m² in step (e) to produce a substrate A.

<Substrate B>

The above steps were carried out in this order in the same manner as above except that steps (g), (h) and (i) were omitted to produce a substrate B.

<Substrate C>

The above steps were carried out in this order in the same manner as above except that steps (a), (g), (h) and (i) were omitted to produce a substrate C.

<Substrate D>

The above steps were carried out in this order in the same manner as above except that steps (a), (d), (e) and (f) were omitted and the total quantity of electricity in step (g) was 450 C/dm², to produce a substrate D.

The substrates A, B, C and D obtained in the above-described manner were successively subjected to the following hydrophilic treatment and undercoating treatment.

(k) Alkali Metal Silicate Treatment

The substrate obtained by anodic oxidation treatment was dipped in a process vessel filled with an aqueous 1% by weight No. 3 sodium silicate solution at 30° C. for 10 seconds to carry out alkali metal silicate treatment (silicate treatment). Thereafter, the substrate was washed with water by spraying. The amount of silicate adhering to the substrate was 3.6 mg/m².

[(1) Formation of an Undercoat Layer]

The aluminum substrate obtained in the above-described manner after the treatment using an alkali metal silicate was coated with an undercoat solution having the following composition, and the undercoat layer was dried at 80° C. for 15 seconds. The coating amount after the coating layer was dried was 18 mg/m².

<Undercoat Solution>

| | | |
|---|---|---|
| High molecular compound shown below | 0.3 | g |
| Methanol | 100 | g |
| Water | 1.0 | g |

| | |
|---|---|
| 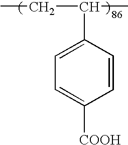 | 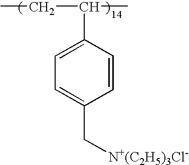 |

| | |
|---|---|
| Weight average molecular weight: | 22,000 |

### Examples 1 to 8

Next, an image recording layer coating solution (photosensitive composition) having the following composition was applied to the substrate and dried at 150° C. for 1 minute to obtain a positive type planographic printing plate precursor having a dry film thickness of 1.7 g/m².

<Image recording layer coating solution>

| | | |
|---|---|---|
| Novolak resin described in Table 3 shown below | 0.93 | g |
| Copolymer of ethylmethacrylate and | 0.07 | g |
| 2-methacryloyloxyethylsuccinic acid | | |
| (molar ratio: 67:33, weight average molecular weight: 110,000) | | |
| Infrared absorber (cyanine dye A: the following structure) | 0.017 | g |
| Infrared absorber (cyanine dye B: the following structure) | 0.023 | g |
| 2,4,6-tris(hexyloxy)benzenediazonium-2- | 0.01 | g |
| hydroxy-4-methoxybenzophenone-5-sulfonate | | |
| p-toluenesulfonic acid | 0.003 | g |
| Cyclohexane-1,2-dicarboxylic acid anhydride | 0.06 | g |
| Dye in which the counter anion of | 0.015 | g |
| Victoria Blue BOH is a 1-naphthalenesulfonic acid anion | | |
| Fluorine type surfactant | 0.02 | g |
| (Megaface F-176, manufactured by | | |
| Dainippon Ink Chemicals, Incorporated) | | |
| Methyl ethyl ketone | 15 | g |
| 1-Methoxy-2-propanol | 7 | g |

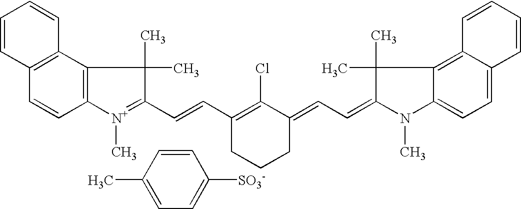

Cyanine dye A

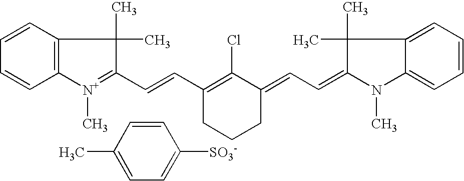

Cyanine dye B

### Comparative Examples 1 and 2

Image recording materials of Comparative Examples 1 and 2 were obtained in the same manner as in Examples 1 to 8, except that novolak resins described in Table 3 shown below were used in place of the novolak resin according to the invention.

TABLE 3

| | (A) Novolak resin composition | | | | | Result of evaluation of | | |
|---|---|---|---|---|---|---|---|---|
| | | | Weight | | | Planographic printing plates | | |
| | | | average | | | | Printing | Chemical |
| | | Compositional | molecular | Degree of | | | durability | resistance |
| | Composition | ratio | weight | dispersion | Substrate | Entanglement | (×10⁴) | (×10⁴) |
| Example 1 | m/p | 70/30 | 4200 | 1.7 | A | A | 23 | 20 |
| Example 2 | Ph/m/p | 50/40/10 | 6700 | 2.8 | B | B | 24 | 21 |
| Example 3 | Ph/m/o | 55/35/10 | 8800 | 5.2 | C | B | 25 | 22 |
| Example 4 | m | 100 | 2800 | 1.4 | D | A | 21 | 20 |
| Example 5 | M/p | 55/45 | 4200 | 1.9 | A | A | 22 | 20 |
| Example 6 | Ph/m/p | 40/40/20 | 7800 | 4.8 | B | A | 24 | 22 |
| Example 7 | Ph/m/o | 60/20/20 | 5700 | 2.7 | C | A | 23 | 21 |
| Example 8 | O | 100 | 1900 | 1.5 | D | B | 21 | 22 |
| Comparative | Ph/m/p | 40/20/40 | 4500 | 5.2 | A | C | 21 | 17 |
| Example 1 | | | | | | | | |
| Comparative | Ph/m/p | 30/40/30 | 4800 | 5.8 | A | D | 20 | 18 |
| Example 2 | | | | | | | | |

With regard to Examples 1 to 4, GPC pattern area ratios of the weight average molecular weights each falling in ranges from 100 to 1000, 1000 to 3000, and 3000 to 30000 were also measured wherein the weight average molecular weight was measured by a gel permeation chromatography (GPC) method using monodispersion polystyrene of a novolak resin as a standard. The results are shown in Table 4 below.

TABLE 4

| | | | Weight | | | | |
|---|---|---|---|---|---|---|---|
| | | | average | | | | |
| | | Compositional | molecular | Degree of | 100-1000 | 1000-3000 | 3000-30000 |
| | Composition | ratio | weight | dispersion | (%) | (%) | (%) |
| Example 1 | M/p | 70/30 | 4200 | 1.7 | 17 | 79 | 4 |
| Example 2 | Ph/m/p | 50/40/10 | 6700 | 2.8 | 15 | 56 | 29 |
| Example 3 | Ph/m/o | 55/35/10 | 8800 | 5.2 | 11 | 57 | 32 |
| Example 4 | M | 100 | 2800 | 1.4 | 17 | 79 | 4 |

Further, with regard to Examples 5 to 8 and Comparative Example 2 in the above table, GPC pattern area ratios of the weight average molecular weights each falling in ranges from 50 to 150, 150 to 350, and 350 to 550 were also measured wherein the weight average molecular weight was measured by a gel permeation chromatography (GPC) method using monodispersion polystyrene of a novolak resin as a standard. The results are shown below.

Example 5: 0.5% (50-150), 1.0% (150-300), 1.3% (350-550)

Example 6: 0.3% (50-150), 0.8% (150-300), 3.0% (350-550)

Example 7: 0.2% (50-150), 0.4% (150-300), 0.8% (350-550)

Example 8: 0.3% (50-150), 1.5% (150-300), 7.0% (350-550)

Comparative Example 2: 1.2% (50-150), 7.8% (150-300), 8.1% (350-550)

### Examples 9 and 10

The following image recording layer coating solution 2 (photosensitive composition) was applied to the obtained substrate A and dried at 150° C. in an oven for 1 minute to obtain a positive type planographic printing plate precursor having a dry film thickness of 1.7 g/m².

<Image recording layer coating solution 2>

| | | |
|---|---|---|
| Novolak resin described in Table 5 shown below | 0.33 | g |
| Novolak resin (phenol/metha-cresol = 35/65) | 0.6 | g |
| Copolymer of ethylmethacrylate and | 0.07 | g |
| 2-methacryloyloxyethylsuccinic acid | | |
| (molar ratio: 67:33, weight average molecular weight: | | |
| 110,000) | | |
| Infrared absorber (cyanine dye A: the following structure) | 0.017 | g |
| Infrared absorber (cyanine dye B: the following structure) | 0.023 | g |
| 2,4,6-tris(hexyloxy)benzenediazonium- | 0.01 | g |
| 2-hydroxy-4-methoxybenzophenone-5-sulfonate | | |
| p-toluenesulfonic acid | 0.003 | g |
| Cyclohexane-1,2-dicarboxylic acid anhydride | 0.06 | g |
| Dye in which the counter anion of | 0.015 | g |
| Victoria Pure Blue BOH is a 1-naphthalenesulfonic acid anion | | |
| Fluorine type surfactant | 0.02 | g |
| (Megaface F-176, manufactured by | | |
| Dainippon Ink and Chemicals, Incorporated) | | |
| Methyl ethyl ketone | 15 | g |
| 1-Methoxy-2-propanol | 7 | g |

### Examples 11 and 12

The following image recording layer coating solution 3 was applied to the obtained substrate A in a coating amount of 0.9 g/m², and then dried at 140° C. for 50 seconds in PERFECT OVEN PH200 manufactured by TABAI wherein Wind Control was set to 7 to obtain an image recording material of Example 8.

<Image recording layer coating solution 3>

| | | |
|---|---|---|
| Novolak resin described in Table 5 shown below | 0.454 | g |
| Copolymer of | 2.10 | g |
| N-(p-aminosulfonylphenyl)methacrylamide, | | |
| ethylmethacrylate and acrylonitrile | | |
| [molar ratio: 32:33:35, weight average molecular weight: | | |
| 53,000, including 0.5% by weight of N-(p- | | |
| aminosulfonylphenyl)methacrylamide as an unreacted | | |
| monomer] | | |
| Cyanine dye A (the above structure) | 0.145 | g |
| 2-Methoxy-4- | 0.02 | g |
| (N-phenylamino)benzenediazonium.hexafluorophosphate | | |
| Tetrahydrophthalic acid anhydride | 0.15 | g |
| Dye in which the counter anion of Ethyl Violet | 0.06 | g |
| is 6-hydroxy-β-naphthalenesulfonic acid | | |
| Fluorine type surfactant | 0.048 | g |
| (Megaface F-176PF, manufactured by | | |
| Dainippon Ink Chemicals, Incorporated) | | |
| Fluorine type surfactant | 0.02 | g |
| (Megaface MCF-312, manufactured by | | |
| Dainippon Ink Chemicals, Incorporated) | | |
| p-Toluenesulfonic acid | 0.009 | g |
| Bis-p-hydroxyphenylsulfone | 0.073 | g |
| n-Dodecyl stearate | 0.02 | g |
| n-Dodecyl palmitate | 0.01 | g |
| Dimyristyl thiodipropionate | 0.05 | g |
| (Sumirizer TPM, manufactured by | | |
| Sumitomo Chemical Co., Ltd.) | | |
| γ-butyrolactone | 16 | g |
| Methyl ethyl ketone | 22 | g |
| 1-Methoxy-2-propanol | 14 | g |

### Examples 13 and 14

A first layer (organic intermediate layer) coating solution was applied to the obtained substrate A by using a wire bar and then dried at 150° C. in a drying oven for 60 seconds such that the coating amount was 0.85 g/m².

A second layer (image recording layer) coating solution was applied to the obtained substrate with the organic intermediate layer by using a wire bar. After being applied, the solution was dried at 145° C. for 70 seconds in a drying oven such that the total coating amount was 1.1 g/m² to obtain a positive-type planographic printing plate precursor.

<First layer (organic intermediate layer) coating solution>

| | | |
|---|---|---|
| Copolymer of | 2.023 | g |
| N-(p-aminosulfonylphenyl)methacrylamide, | | |
| ethylmethacrylate and acrylonitrile | | |
| [molar ratio: 41:23:36, weight average molecular | | |
| weight: 48,000, including 0.8% by weight of | | |
| N-(p-aminosulfonylphenyl)methacrylamide as an unreacted | | |
| monomer] | | |
| Cyanine dye A (the above structure) | 0.088 | g |
| 2-Mercapto-5-methylthio-1,3,4-thiadiazole | 0.040 | g |
| Cis-Δ⁴-tetrahydrophthalic acid anhydride | 0.200 | g |
| 4,4′-sulfonyldiphenol | 0.080 | g |
| p-Toluenesulfonic acid | 0.006 | g |
| Dye in which the counter anion of Ethyl Violet is | 0.200 | g |
| 6-hydroxynaphthalenesulfonic acid | | |
| 3-methoxy-4-diazodiphenylaminehexafluorophosphate | 0.030 | g |
| Fluorine type surfactant (the following polymer 1) | 0.035 | g |
| Methyl ethyl ketone | 23.6 | g |
| 1-Methoxy-2-propanol | 13.6 | g |
| γ-butyrolactone | 11.8 | g |
| Polymer-1 | | |
| 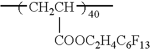 | | |
| 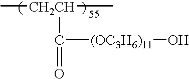 | | |
| 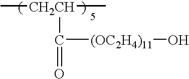 | | |

<Second layer (image recording layer) coating solution>

| | | |
|---|---|---|
| Copolymer of ethylmethacrylate and | 0.052 | g |
| 2-methacryloyloxyethylsuccinic acid | | |
| (molar ratio: 67:33, weight average molecular | | |
| weight: 110,000) | | |
| Novolak resin described in Table 5 below | 0.318 | g |
| Cyanine dye A (the above structure) | 0.0215 | g |
| Cyanine dye B (the above structure) | 0.0075 | g |
| 5-Benzoyl-4-hydroxy-2-methoxybenzene sulfonate of 1-(4- | 0.007 | g |
| methylbenzyl)-1-phenylpiperidinium | | |
| Fluorine-type surfactant (the above polymer 1) | 0.012 | g |
| Fluorine-type surfactant (the following polymer 2) | 0.003 | g |
| Methyl ethyl ketone | 12.1 | g |
| 1-Methoxy-2-propanol | 4.39 | g |

TABLE 5

| | (A) Novolak resin composition | | | | | Result of evaluation of | | |
|---|---|---|---|---|---|---|---|---|
| | | | Weight | | | planographic printing plates | | |
| | | | average | | | | Printing | Chemical |
| | | Compositional | molecular | Degree of | | | durability | resistance |
| | Composition | ratio | weight | dispersion | Substrate | Entanglement | (×10⁴) | (×10⁴) |
| Example 9 | m/p | 70/30 | 4500 | 1.9 | D | B | 25 | 22 |
| Example 10 | m/p | 85/15 | 4800 | 2.1 | D | B | 24 | 22 |
| Example 11 | Ph/m | 20/80 | 4300 | 1.8 | A | A | 24 | 21 |
| Example 12 | Ph/m | 40/60 | 4400 | 2 | A | A | 22 | 20 |
| Example 13 | Ph/m/p | 20/40/40 | 5400 | 2.5 | A | B | 23 | 20 |
| Example 14 | Ph/m/p | 30/50/20 | 4500 | 1.6 | A | A | 23 | 21 |

With regard to Examples 10, 12 and 14 in the above table, GPC pattern area ratios of the weight average molecular weights each falling in ranges from 50 to 150, 150 to 350, and 350 to 550 were also measured wherein the weight average molecular weight was found by a gel permeation chromatography (GPC) method using monodispersion polystyrene of a novolak resin as a standard. The results are shown below.

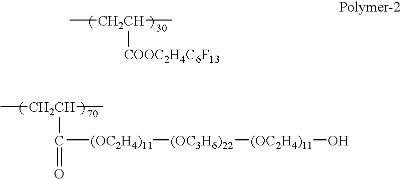

Example 10: 0.4% (50-150), 2.8% (150-300), 1.2% (350-550)

Example 12: 0.3% (50-150), 1.2% (150-300), 1.6% (350-550)

Example 14: 0.2% (50-150), 0.3% (150-300), 0.4% (350-550)

(Evaluation of the Planographic Printing Plate Precursor)

The obtained planographic printing plate was evaluated according to the following standard. The results are described in Tables 3 and 4 in addition to other results.

(Printing Durability)

A test pattern was written image-wise in each planographic printing precursor obtained in Examples 1 to 14 and Comparative Examples 1 and 2 by using Trendsetter 3244F manufactured by Creo by changing the exposure energy. Thereafter, the planographic printing precursor was developed using PS Processor LP940H manufactured by Fuji Photo Film Co., Ltd., which processor had been charged with a developer produced by blowing CO₂ gas to Developer LH-DRS manufactured by Fuji Photo Film Co., Ltd., such that electric conductivity of the developer reached 78 mS/cm, and a finisher produced by diluting Finisher FP-2W manufactured by Fuji Photo Film Co., Ltd., with water (the dilution ration was 1:1), under a condition of a developing temperature of 30° C. and a developing time of 12 seconds. This planographic printing plate precursor was set to a printer Lithron manufactured by Komori Corporation to carry out continuous printing. At this time, the number of copies on which printing was made by maintaining sufficient ink density was visually measured to evaluate the printing durability of the planographic printing plate precursor. Evaluation was made based on the criteria in which the larger the number of copies, the higher the printing durability.

(Chemical Resistance)

Exposure, developing and printing were carried out in the same manner as in the case of evaluating the above printing durability. At this time, an additional step of cleaning the surface of the plate by using a cleaner (Multi-cleaner manufactured by Fuji Photo Film Co., Ltd.) was performed for every 5000 prints to evaluate the chemical resistance. Evaluation was made based on the criteria in which the larger the number of copies, the higher the chemical resistance.

(Entanglement of a Dot Image Portion)

The surface of the plate was cleaned using a burning surface regulating solution BC-7 manufactured by Fuji Photo Film Co., Ltd., and the plate was treated by a burning apparatus BP-1300 for 7 minutes. Then, the plate surface was treated using a solution prepared by diluting 2 unit of a Gum FP-2W manufactured by Fuji Photo Film Co., Ltd., with 1 unit of water and allowed to stand for one day. Then, the plate was set to a Hidel KOR-D machine to carry out printing. The burning temperature, the number of the obtained copies, and the degree of entanglement of the dot image portion are shown in the following table.

(Degree of Entanglement of the Dot Image Portion)

A: No entanglement is observed.

B: Little entanglement is observed.

C: Slight entanglement is observed.

D: Entanglement is clearly observed.

E: Severe entanglement is observed.

As is clear from the aforementioned Tables 3 and 4, the planographic printing plate precursors obtained in Examples 1 to 14 in the invention are superior in all of printing durability, chemical resistance and entangling characteristics, showing that the printing durability of image portions such as fine lines and dots is improved, making it possible to form an image with high contrast. As is evident from Examples 13 and 14, it is confirmed that even a case where the image recording layer takes a multilayer structure in combination with an organic intermediate layer, the planographic printing plate precursors are also likewise superior in printing durability, chemical resistance and entangling characteristics.

On the other hand, it is apparent that the planographic printing plate precursors of Comparative Examples 1 and 2 using a novolak-type phenol resin having a degree of dispersion outside the range defined in the invention is particularly inferior in chemical resistance and entangling characteristics, compared to the planographic printing plate precursors of the present Examples.

1. A positive-type planographic printing plate precursor comprising:
a hydrophilic substrate; and
an image recording layer including a novolak resin (A) and a light-to-heat conversion agent (B), disposed on the substrate, the image recording layer increasing in solubility in an aqueous alkali solution when exposed to light emitted from an infrared laser,
wherein the weight average molecular weight (Mw) of the novolak resin (A) ranges from 500 to 3000 based on polystyrene, the molecular weight being measured by a gel permeation chromatographic (GPC) method using monodispersion polystyrene as a standard, and the degree of dispersion (Mw/Mn) of the novolak resin (A) is 1.7 or less.

2. A positive-type planographic printing plate precursor according to claim 1, wherein, when the weight average molecular weight of the novolak resin (A) based on polystyrene is found by a gel permeation chromatographic (GPC) method using monodispersion polystyrene as a standard, the GPC-pattern area ratios of the weight average molecular weights each falling in ranges from 50 to 150, 150 to 350, and 350 to 550 are 1% or less, 10% or less, and 20% or less, respectively, based on the total area.

3. A positive-type planographic printing plate precursor according to claim 1, wherein the amount of the novolak resin (A) to be added is 0.1 to 20% by weight based on the total solid in the image recording layer.

4. A positive-type planographic printing plate precursor according to claim 1, wherein, when the weight average molecular weight of the novolak resin (A) based on polystyrene is found by a gel permeation chromatographic (GPC) method using monodispersion polystyrene as a standard, the GPC-pattern area ratios of the weight average molecular weights each falling in ranges from 100 to 1000, 1000 to 3000, and 3000 to 30000 are 5 to 20%, 50 to 80%, and 10 to 35%, respectively, based on the total area.

5. A positive-type planographic printing plate precursor according to claim 1, wherein a novolak resin other than the novolak resin (A) is used in combination with the novolak resin (A).

6. A positive-type planographic printing plate precursor according to claim 1, wherein the positive-type planographic printing plate precursor is developed with a developer containing a non-ionic surfactant.

7. A positive type planographic printing plate precursor comprising:
a hydrophilic substrate; and
an image recording layer including a novolak resin (A) and a light-to-heat conversion agent (B), disposed on the substrate, the image recording layer increasing in solubility in an aqueous alkali solution when exposed to light emitted from an infrared laser,
wherein the weight average molecular weight (Mw) of the novolak resin (A) ranges from 3000 to 4500 based on polystyrene, the molecular weight being measured by a gel permeation chromatographic (GPC) method using monodispersion polystyrene as a standard, and the degree of dispersion (Mw/Mn) of the novolak resin (A) is 2.0 or less.

8. A positive-type planographic printing plate precursor according to claim 7, wherein, when the weight average molecular weight of the novolak resin (A) based on polystyrene is measured by a gel permeation chromatographic (GPC) method using monodispersion polystyrene as a standard, the GPC-pattern area ratios of the weight average molecular weights each falling in ranges from 50 to 150, 150 to 350, and 350 to 550 are 1% or less, 4% or less, and 4.5% or less, respectively, based on the total area.

9. A positive-type planographic printing plate precursor according to claim 7, wherein the amount of the novolak resin (A) to be added is 0.1 to 20% by weight based on the total solid in the image recording layer.

10. A positive-type planographic printing plate precursor according to claim 7, wherein, when the weight average molecular weight of the novolak resin (A) based on polystyrene is found by a gel permeation chromatographic (GPC) method using monodispersion polystyrene as a standard, the GPC-pattern area ratios of the weight average molecular weights each falling in ranges from 100 to 1000, 1000 to 3000, and 3000 to 30000 are 5 to 20%, 50 to 80%, and 10 to 35%, respectively, based on the total area.

11. A positive-type planographic printing plate precursor according to claim 7, wherein a novolak resin other than the novolak resin (A) is used in combination with the novolak resin (A).

12. A positive-type planographic printing plate precursor according to claim 7, wherein the positive-type planographic printing plate precursor is developed with a developer containing a non-ionic surfactant.

13. A positive type planographic printing plate precursor comprising:
a hydrophilic substrate; and
an image recording layer including a novolak resin (A) and a light-to-heat conversion agent (B), disposed on the substrate, the image recording layer increasing in solubility in an aqueous alkali solution when exposed to light emitted from an infrared laser,
wherein the weight average molecular weight (Mw) of the novolak resin (A) ranges from 4500 to 10000 based on polystyrene, the molecular weight being measured by a gel permeation chromatographic (GPC) method using monodispersion polystyrene as a standard, and the degree of dispersion (Mw/Mn) of the novolak resin (A) satisfies the following equation: (Mw/Mn)≦{(4·Mw−1500)/5500}.

14. A positive type planographic printing plate precursor according to claim 13, wherein, when the weight average molecular weight of the novolak resin (A) based on polystyrene is measured by a gel permeation chromatographic (GPC) method using monodispersion polystyrene as a standard, the GPC-pattern area ratios of the weight average molecular weights each falling in ranges from 50 to 150, 150 to 350, and 350 to 550 are 1% or less, 3% or less, and 3.5% or less, respectively, based on the total area.

15. A positive-type planographic printing plate precursor according to claim 13, wherein the amount of the novolak resin (A) to be added is 0.1 to 20% by weight based on the total solid in the image recording layer.

16. A positive-type planographic printing plate precursor according to claim 13, wherein, when the weight average molecular weight of the novolak resin (A) based on polystyrene is found by a gel permeation chromatographic (GPC) method using monodispersion polystyrene as a standard, the GPC-pattern area ratios of the weight average molecular weights each falling in ranges from 100 to 1000, 1000 to 3000, and 3000 to 30000 are 5 to 20%, 50 to 80%, and 10 to 35%, respectively, based on the total area.

17. A positive-type planographic printing plate precursor according to claim 13, wherein a novolak resin other than the novolak resin (A) is used in combination with the novolak resin (A).

18. A positive-type planographic printing plate precursor according to claim 13, wherein the positive-type planographic printing plate precursor is developed with a developer containing a non-ionic surfactant.
